(19) United States
(12) Patent Application Publication
(10) Pub. No.: US 2012/0305762 A1
(43) Pub. Date: Dec. 6, 2012

(54) ION ISOLATION METHOD AND MASS SPECTROMETER

(76) Inventors: Akihito Kaneko, Kawasaki (JP); Atsumu Hirabayashi, Kodaira (JP)

(21) Appl. No.: 13/579,334

(22) PCT Filed: Dec. 13, 2010
(86) PCT No.: PCT/JP2010/072331

§ 371 Date: Aug. 16, 2012

(30) Foreign Application Priority Data
Mar. 24, 2010 (JP) 2010-067205

(51) Int. Cl. H01J 49/42; B01D 59/46

(52) U.S. Cl. 250/283; 250/288

(57) ABSTRACT

Disclosed is a method whereby predetermined ions are isolated and ions to be left in an ion trap are left at the time of performing mass spectrometry using the ion trap. In order to have high ion isolation accuracy and to shorten a time necessary for ion isolation, a first time wherein ions having a lower mass than the ions to be left are isolated is set shorter than a second time wherein ions having a higher mass than the ions to be left are isolated.

### TECHNICAL FIELD

The present invention relates to an ion trap mass spectrometer for use in analysis of organism-related materials, etc. More specifically, the invention relates to a technology for enabling only ions with their mass-to-charge ratios (m/z) within a predetermined range to be left in the ion trap of an ion trap mass spectrometer.

### BACKGROUND ART

A quadrupole ion trap mass spectrometer enables ions to be trapped for a predetermined time period using an Rf electric field and enables the ions thus concentrated to be ejected sequentially from the ion trap depending on their mass-to-charge ratios (m/z) so as to be detected by a detector. In this manner, mass spectrometry can be achieved.

It is also possible to perform tandem mass spectrometry in which predetermined ions are dissociated and the mass spectrum of the dissociated ions (i.e., fragment ions) are obtained. More specifically, ions of two or more species are first accumulated within the ion trap, and precursor ions to be analyzed by the tandem mass spectrometry are then selected from among the accumulated ions.

Thereafter, isolation is performed by ejecting all the ions other than the selected precursor ions from the ion trap so that only the precursor ions are left in the ion trap.

The isolated precursor ions are then dissociated by a dissociating method, such as CID (Collision-Induced Dissociation), IRMPD (InfraRed Multi Photon Dissociation), ECD (Electron Capture Dissociation), or ETD (Electron Transfer Dissociation), so that the dissociated ions thus generated are accumulated in the ion trap.

The dissociated ions are then ejected from the ion trap depending on their m/z values to be detected by a detector, thus enabling the m/z values of the dissociated ions to be determined. It is also possible to perform MSⁿ analysis (MS/MS/MS, MS/MS/MS/MS) in which isolation is performed so that predetermined dissociated ions are left as precursor ions and the precursor ions are then further dissociated.

A known isolation method used in a quadrupole ion trap will now be described.

Although quadrupole ion traps are classified into several classes, such as three dimensional quadrupole ion traps (3DQ) including a ring electrode and a pair of bowl-shaped electrodes and linear ion traps (LIT) including parallel pole electrodes, all of them operate on the same principle.

That is, while ions are trapped within a predetermined space in a quadrupole ion trap, they not only oscillate slightly due to an Rf voltage applied across electrodes facing each other at a frequency identical to the Rf frequency (micro motion) but also oscillate at a frequency that is lower than the Rf frequency (secular motion).

Here, the frequency of the secular motion varies depending on the m/z values of the ions. Therefore, if an AC electric field (supplemental AC) having the same frequency as the frequency of the secular motion corresponding to the m/z of a certain ion is applied to the space in which the ion is trapped, the amplitude of the secular motion of the ion is increased due to resonance.

As the potential of the supplemental AC is increased, the amplitude of the motion of the ion in resonance increases, and the ion will be eventually ejected from the ion trap due to collision with electrodes, dissociation through collision with a residual gas, etc.

In addition, Increasing the length of time for which the ion is exposed to the supplemental AC increases the possibility of the ion being ejected from the ion trap due to dissociation through collision with the residual gas, etc.

Ion isolation is typically performed on the basis of the above principle.

When ions of two or more species are trapped in a quadrupole ion trap, isolation in which all the ions other than the precursor ions are ejected leaving only the precursor ions can be achieved by applying a supplemental AC having frequencies corresponding to the m/z values of the other ions so that the other ions are resonance-ejected.

However, when the number of species other than the precursor ion species is very high or when their m/z values are unknown, it is advantageous to sweep (i.e., to vary) the frequency of the supplemental AC within a range in which the precursor ions do not come into resonance so that all the other ions are sequentially resonance-ejected. In that case, it is ideal that all the other ions be ejected completely with all the precursor ions retained as-is.

To this end, the Rf voltage needs to be increased so that the secular motion is stabilized when the precursor ions are trapped. The following values a and q are known as indicators associated with the stability of the secular motion.

$$\begin{matrix}a = \frac{8 eU}{{m}_{z} {{r}^{2} ( 2 π F )}^{2}} & Expression 1 \\ q = \frac{4 e {V}_{RF}}{{m}_{z} {{r}^{2} ( 2 π F )}^{2}} & Expression 2\end{matrix}$$

Here, e denotes the elementary electric charge, U denotes the DC voltage applied to the ion trap, r denotes the radius of space formed by ion trap electrodes, m_{z} denotes the m/z of the ion, F denotes the Rf frequency, and V_{RF} denotes the Rf voltage.

As the DC voltage U is typically set to 0 volts, the a-value becomes zero. As a result, the stability of the secular motion is eventually represented by the q-value.

In that case, the secular motion may be considered stable if the q-value is equal to or less than about 0.908, and it is known that the higher the q-value becomes, the more the secular motion is stabilized and the more the resonance ejection is likely to occurs.

However, depending on the structure of the quadrupole ion trap or the m/z of the precursor ions, it may be difficult to vary the frequency of the supplemental AC due to constraints imposed by the power supply for generating the Rf voltage, etc.

Here, it is known that there exists a relationship represented by Expression 3 below between the q-value and the resonance frequency fr at which the ion is resonance-ejected.

$${f}_{r} = \frac{qF}{\sqrt{2}} \qquad Expression 3$$

Combining Expressions 2 and 3 reveals that the similar resonance ejection can also be achieved by sweeping the Rf voltage (V_{RF}) with the frequency of the supplemental AC fixed (Patent Literature 1).

For example, isolation can be achieved by first applying a predetermined supplementary AC, then sweeping the Rf voltage so as to resonance-eject ions having their m/z values lower than that of the precursor ions, and finally sweeping the Rf voltage so as to resonance-eject ions having their m/z values higher than that of the precursor ions.

It is also possible to combine two or more supplemental AC components having different frequencies so that ions having different m/z values can be resonance-ejected at once. This is advantageous to increase the analytical throughput.

More specifically, if it is possible to generate a supplemental AC having various frequencies so that all the ions other than the precursor ions can be ejected at once, isolation can be completed in a short time. Methods referred to as FNF (Filtered Noise Field) (Patent Literature 3), SWIFT (Stored Waveform Inverse Fourier Transform), etc. operate on this principle. A waveform generated in this manner is a typical broadband waveform, and is configured so that only the amplitudes of components having frequencies at which the ions to be isolated come into resonance are reduced to zero.

Such a waveform is actually generated by combining multiple supplemental AC components having regularly spaced frequencies. For this reason, for ions that come into resonance at a frequency located in between any two adjacent frequencies, the resonance ejection efficiency is not necessarily high because the amplitude of the supplemental AC is relatively low.

In view of the foregoing problem, it is advantageous to apply a broadband waveform having a relatively high potential for a predetermined time period or to sweep the Rf voltage (q-value) as described above.

It is also possible to perform isolation by sweeping the Rf voltage for ions having m/z values lower than the m/z value of the precursor ions with a fixed supplemental AC applied so that the ions in the lower m/z range are ejected and applying a broadband waveform having a corresponding frequency range for the ions in the higher m/z range for a relatively short time period.

Using such an approach can prevent harmonics generated by the broadband waveform from affecting the analytical result. On the other hand, when a narrow m/z range having a width of 1 Da (dalton) or less is isolated, it is advantageous to sweep the Rf voltage (q-value) taking into consideration the fact that the frequency of the supplemental AC is close to the resonance frequency corresponding to the central m/z of the isolation.

In this manner, depending on the situation, a supplemental radio frequency (Supplemental Rf), such as a supplemental AC having a single frequency only, a combination of supplemental AC components having different frequencies, or a broadband AC in which various frequencies are combined, may be used in addition to the original Rf, so that the amplitude of the secular motion is increased thus enabling the resonance ejection to Occur.

In addition, because three dimensional quadrupole ion traps have holes formed through their electrodes having curved surfaces so as to eject ions, the quadrupole electric field inside the ion trap may be distorted. Therefore, one or more external electrodes may be disposed to correct the field distortion, so that high accuracy isolation can be achieved.

When isolation is performed, tuning may need to be carried out depending on the measurement purpose by e.g., increasing the throughput, removing ions other than the precursor ions thoroughly, minimizing the ejection and dissociation of the precursor ions, and defining the isolation width in a more accurate manner (Patent Literature 4).

### CITATION LIST

### Patent Literature

Patent Literature 1: U.S. Pat. No. 4,736,101
Patent Literature 2: U.S. Pat. No. 4,749,860
Patent Literature 3: U.S. Pat. No. 5,134,286
Patent Literature 4: U.S. Pat. No. 7,456,396
Patent Literature 5: U.S. Pat. No. 5,640,011
Patent Literature 6: U.S. Pat. No. 7,285,773

### Nonpatent Literature

Nonpatent Literature 1: K. R. Jonscher and J. R. Yates III, The Whys and Wherefores of Quadrupole Ion Trap Mass Spectrometry, ABRF News, 7, 1-15 (1996).
Nonpatent Literature 2: M. H. Soni and G. R. Cooks, Selective Injection and isolation of ions in quadrupole ion trap mass spectrometry using notched waveforms created using the inverse Fourier transform, Analytical Chemistry 66, 2488-2496 (1994).

### SUMMARY OF INVENTION

### Technical Problem

In order to increase the overall analytical throughput and sensitivity of mass spectrometry using an ion trap, isolation needs to be performed at a high speed. The accumulation time in which ions are introduced may often be on the order of a few milliseconds although it varies depending on the amount of ions to be introduced into the ion trap. In view of such a short accumulation time, it is preferable that the length of time required to perform isolation be equal to or less than the accumulation time. Typically, it is preferable that isolation be completed within five milliseconds

Furthermore, in order to increase the throughput, it is necessary to use a broadband supplemental Rf obtained by combining multiple frequencies so that the frequency components corresponding to a certain mass range are reduced to provide a frequency window, instead of the approach in which a supplemental Rf having a single frequency is applied and the frequency thereof or the Rf voltage is swept. However, in that case, because the ions in a mass range higher than the ions to be isolated are less likely to be resonance-ejected than the ions in a mass range lower than the ions to be isolated, there may be caused a problem in that the ions on the higher mass side cannot be thoroughly ejected if the length of time allocated for the resonance ejection is reduced in a uniform manner.

Furthermore, there is another problem in that unstable ions may be dissociated because the frequency components corresponding to the frequency window cannot be eliminated completely. More specifically, with advances in the soft ionization technology, an increasing number of very unstable ions are starting to be analyzed. Typical examples of such ions include glycosylated peptides, protonated molecules of some low molecular weight compounds, etc. However, when such unstable ions are selected as the precursor ions, a large amount of precursor ions may be lost during the isolation process in the ion trap, thus reducing the analytical sensitivity. For this reason, in order to achieve high throughput and high sensitivity analysis, it is important to avoid loss of ions during the isolation process not only for relatively stable ions but also for relatively unstable ions.

An object of the present invention is to provide a method for mass spectrometry using an ion trap that enables unnecessary ions to be ejected thoroughly and enables high speed isolation to be performed while sufficient sensitivity for ions to be left is maintained.

### Solution to Problem

An aspect of the present invention uses an ion isolation method comprising: an introduction step for introducing a plurality of ions into an ion trap having a plurality of electrodes; a trapping step for applying an RF voltage to at least one of the plurality of electrodes at a first potential to trap the plurality of ions within the ion trap; a first isolation step for applying a supplemental RF voltage to the electrode to which the RF voltage is applied, increasing the RF voltage above the first potential, and continuing the application of the RF voltage at the increased potential for a first time period such that ion isolation is performed; a second isolation step for, with the supplemental RF voltage applied to the electrode to which the RF voltage is applied, reducing the RF voltage below the first potential and continuing the application of the RF voltage at the reduced potential for a second time period longer than the first time period such that ion isolation is performed; and an ejection step for ejecting the ions remaining in the ion trap.

Another aspect of the present invention uses a mass spectrometer comprising: an ion source unit for generating a plurality of ions by ionizing a sample; an ion trap unit including an ion trap having a plurality of electrodes, an AC power supply for applying an AC electric field to the plurality of electrodes, and a controller for controlling the AC power supply; and a detector unit for detecting the plurality of ions depending on their mass-to-charge ratios. The mass spectrometer is characterized in that the controller controls the AC power supply to perform ion isolation by applying an RF voltage to at least one of the plurality of electrodes at a first potential to trap the plurality of ions, applying a supplemental RF voltage to the electrode to which the RF voltage is applied, increasing the RF voltage above the first potential, continuing the application of the RF voltage at the increased potential for a first time period, reducing the RF voltage below the first potential, and continuing the application of the RF voltage at the reduced potential for a second time period longer than the first time period.

### Advantageous Effects of Invention

An exemplary mass spectrometric method disclosed herein can complete isolation of precursor ions within a very short time.

In doing so, the method solves the problem that the ions on the higher mass side are less likely to be ejected when compared to the ions on the lower mass side. Furthermore, another exemplary mass spectrometric method according to the invention enables loss of ions during the isolation process to be suppressed to a very low level even if not only relatively stable ions but also relatively unstable ions are selected as the precursor ions.

As a result, high throughput and high sensitivity tandem mass spectrometry can be performed even for a sample including relatively unstable ions, such as glycosylated peptides.

### BRIEF DESCRIPTION OF DRAWINGS

FIG. 1 is a schematic diagram showing the device configuration of a mass spectrometer for performing an exemplary mass spectrometric method of the invention.

FIG. 2 is a diagram showing a control sequence of signals transmitted to a linear ion trap and peripheral units thereof.

FIG. 3 is a schematic diagram showing the configuration of the ion trap unit, the method for connecting the AC and DC signals, and the flow of ions when a linear ion trap is used as the ion trap unit shown in FIG. 1.

FIG. 4 is a schematic diagram as viewed from the axial direction in which ions pass through the linear ion trap.

FIG. 5 is a schematic diagram showing the configuration of the ion trap unit when a three dimensional quadrupole ion trap is used as the ion trap unit shown in FIG. 1.

FIG. 6 is a schematic diagram showing the cross-unit of the three dimensional quadrupole ion trap and the method for connecting the AC and DC signals.

FIG. 7 is a schematic diagram showing the principle on which ions are resonance-ejected from an ion trap.

FIG. 8 is a diagram showing the relationship between a-value and q-value which serve as indicators for indicating the stability of trapped ions.

FIG. 9 is a diagram showing the power spectrum when an FNF is used as the supplemental Rf, illustrating that a gap actually exists between any two adjacent frequency components where multiple frequencies are superimposed.

FIG. 10 is a diagram showing an exemplary achievable control sequence of the Rf voltage applicable in a method for isolating ions that are less likely to be dissociated.

FIG. 11 is a diagram showing an exemplary achievable control sequence of the Rf voltage applicable in an isolation method in which sweeping is performed.

FIG. 12 is a diagram showing the power spectrum when an FNF is used as the supplemental Rf, illustrating the vicinity of the frequencies corresponding to the ions of interest in an enlarged manner.

FIG. 13 is a diagram showing an exemplary achievable control sequence of the Rf voltage applicable in a method for isolating ions that are likely to be dissociated.

FIG. 14 is a diagram showing an exemplary achievable control sequence of the Rf voltage applicable when the throughput needs to be increased in FIG. 13.

FIG. 15 is a diagram showing an exemplary achievable control sequence of the Rf voltage applicable when ions unlikely to be isolated exist on the higher mass side in FIG. 13.

FIG. 16 is a diagram showing an exemplary achievable control sequence of the Rf voltage applicable when the ions in FIG. 15 are more unlikely to be isolated.

FIG. 17 is a diagram showing the differences between methods for achieving a circuit for changing the gradient of the Rf voltage sweeping.

FIG. 18 is a diagram showing an exemplary achievable control sequence of the Rf voltage applicable in a method for isolating ions that are very likely to be dissociated.

FIG. 19 is a diagram showing an exemplary achievable control sequence of the Rf voltage applicable when ions to be ejected exist in the immediate vicinity of the precursor ions on the lower mass side.

FIG. 20 is a diagram showing an exemplary achievable control sequence of the Rf voltage in which the isolation time for the higher mass side is set short in FIG. 19.

FIG. 21 is a diagram showing an exemplary achievable control sequence of the Rf voltage applicable when a supplemental Rf having a single frequency is used as the supplemental Rf.

FIG. 22 is a diagram showing an exemplary achievable control sequence of the Rf voltage applicable when a supplemental Rf having two frequencies is used as the supplemental Rf.

FIG. 23 shows an exemplary spectrum obtained when the trivalent ions of Substance P (RPKPQQFFGLM) were actually isolated.

FIG. 24 is an exemplary pre-isolation spectrum obtained immediately before the isolation shown in FIG. 23 was performed.

FIG. 25 shows an exemplary screen used for selecting one of a plurality of modes representing different ion isolation methods.

### DESCRIPTION OF EMBODIMENTS

The present invention achieves a configuration in which the Rf voltage (q-value) can be swept with the supplemental Rf applied irrespective of the type of ion trap.

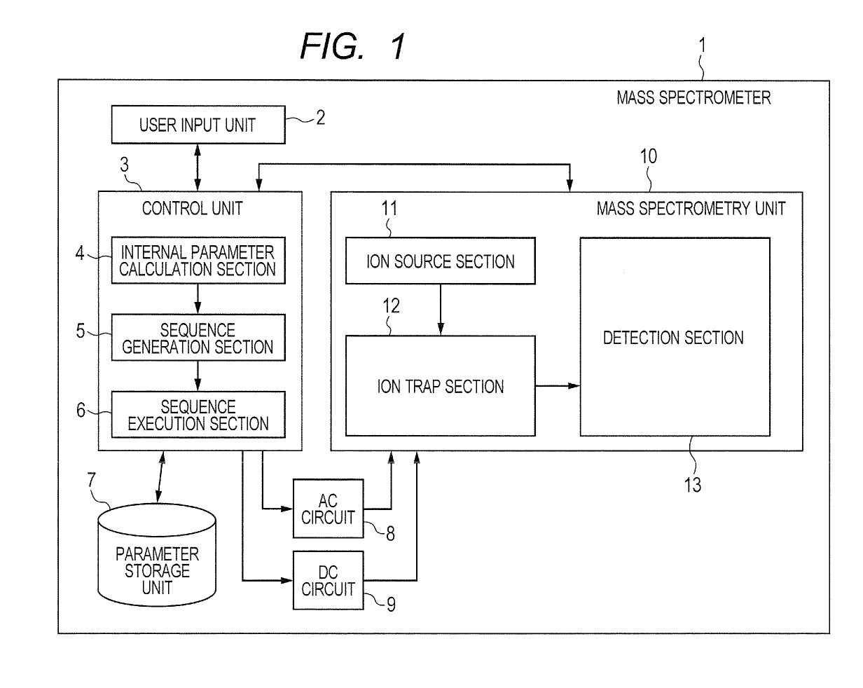

FIG. 1 shows the configuration of a mass spectrometer for performing an exemplary mass spectrometric method according to the invention. The mass spectrometer 1 includes a user interface unit 2, a control unit 3, a parameter storage unit 7, an AC circuit unit 8, and a DC circuit unit 9, and a mass spectrometer unit 10. The control unit 3 includes an internal parameter calculation unit 4, a control sequence preparation unit 5, and a control sequence execution unit 6. The mass spectrometer unit 10 includes an ion source unit 11, an ion trap unit 12, and a detector unit 13. Although in this example, the ion source unit 11 is directly connected with the ion trap unit 12 and the ion trap unit 12 is directly connected with the detector unit 13, other one or more devices may also be included therebetween for tandem mass spectrometry.

First, the user of the mass spectrometer 1 may input parameters for isolation via the user interface unit 2. This, user interface unit 2 enables the user to specify parameters for not only the case in which ions of predetermined species are isolated but also the case in which the precursor ions are automatically selected and analyzed such as when a data-dependent analysis is performed.

When ions of predetermined species are isolated, a plurality of ion species can be set as the ions of interest and a plurality of values can be set for each parameter accordingly.

When automatic analysis is performed, on the basis of the information stored in the parameter storage unit 7, past records obtained by analyzing specific ions can be retrieved, previously set tables can be used, previously set functions regarding m/z and electric charge can be used, or any combination thereof can be carried out.

More specifically, the user interface unit 2 may be used to input specific parameters, i.e., the m/z of the precursor ions, parameters for the supplemental Rf, parameters specifying the shift amount of the supplemental Rf toward the precursor ions during isolation (in Da), and sweeping parameters for each of the lower and higher mass sides.

As the parameters for the supplemental Rf, when a waveform obtained by combining one or more frequencies is used as the supplemental Rf, their frequencies may be specified, and when a broadband waveform in which multiple components are combined is used as the supplemental Rf, the width of the frequency window including the m/z of the precursor ions may be specified.

It is also possible to separately set the supplemental Rf parameters for the lower mass side and the higher mass side of the precursor ions.

As the sweeping parameters, parameters specifying the shift amount of the supplemental Rf toward the target mass range, parameters specifying the range in which the Rf voltage is swept therefrom, and parameters specifying the gradient of the Rf voltage sweeping may be specified for Mode 1. For Mode 2, any arbitrary function for the Rf voltage may be set as the sweeping parameter. This function needs to be defined as a function of time. All the parameters can be stored in the parameter storage unit 7. The stored parameters can be retrieved via the user interface unit 2 for later use, while it is also possible to combine the retrieved parameters to generate a new parameter.

Instead of the m/z of the precursor ions, it is also possible to specify a list of the m/z values of the precursor ions, a list of the valences of the precursor ions, a list of combinations of the m/z value and valence of the precursor ions, the ranges of the precursor ions, a list of combinations of the range and valence of the precursor ions, and a list of any combination thereof can also be specified to be used as the parameters for automatic analysis. When liquid chromatography is included and used in the ion source unit 11, the retention time (hereinafter abbreviated as RT) for the precursor ions within the liquid chromatography also can be specified in combination with the m/z of the precursor ions or in combination with a combination of the m/z and valence of the precursor ions.

When the RT is specified in combination with the m/z, even if the m/z is matched, the ions are distinguished from the precursor ions if the RT is not matched. When the RT is specified in combination with both the m/z and valence, even if both the m/z and valence are matched, the ions are distinguished from the precursor ions if the RT is not matched.

It is also possible to specify parameters for ions that do not correspond to the specified m/z or m/z list of the precursor ions (i.e., default parameters) by specifying no m/z values of the precursor ions.

Furthermore, when ions previously included in the sample have a certain characteristic tendency, as is the case with glycosylated proteins or peptides, it is possible to set parameters adjusted to the specific characteristic, and it is also possible to prepare, edit, and store calculation formulae for automatically setting parameters on the basis of a calculation method that enables parameters to be set depending on the charges and mass-to-charge ratios of ions and to retrieve the stored formulae to set parameters.

More specifically, once the m/z and valence of the precursor ions and the degree of dissociatability thereof are selected and the width (in Da) of a range in which ions including the precursor ions are isolated is specified, parameters for the supplemental Rf, parameters specifying the shift amount of the supplemental Rf toward the precursor ions during isolation (in Da), and sweeping parameters for each of the lower and higher mass sides are automatically set.

It is also possible to manually modify the parameters automatically set in this manner in whole or in part.

Although the dissociatability of ions is basically divided into two levels, i.e., likely to be dissociated and unlikely to be dissociated, it is also possible to increase the number of levels and to set the associated parameters accordingly.

The control unit 3 transmits and receives signals to and from the mass spectrometer unit 10, the ion source unit 11, the ion trap unit 12, and the detector unit 13, and transmits signals to the AC circuit unit 8 and the DC circuit unit 9, thereby controlling them.

On the basis of the input parameters, the control unit 3 can not only perform analysis in which only ions of certain species are analyzed using the parameters set for the ion species but also perform analysis by automatically selecting ions and automatically setting parameters for them. The control unit 3 can also perform analysis in which the function for specifying certain ion species and the function for automatically setting parameters are combined, i.e., if certain ion species is detected, analysis can be performed on the basis of the parameters set for the ion species, otherwise, parameters can be automatically set to perform analysis. Furthermore, the control unit 3 can also set parameters in a real-time manner on the basis of information obtained by the detector unit 13 during analysis, and can perform further analysis.

More specifically, when analysis is performed, with liquid chromatography included in the configuration of the ion source unit 11, each ion species is typically measured using a separate time width. Therefore, it is possible to first perform analysis using specified parameters in the early part of the time width and then reset the parameters in the control unit 3 on the basis of the information obtained by the detector unit 13, such as the m/z, valence, and cleavage pattern in tandem mass spectrometry of the ions thereby performing analysis again under better conditions in the rest of the time width.

Furthermore, when the information obtained by the detector unit 13 corresponds to a list previously set via the user interface unit 2, it is possible to make use of the past records by performing analysis on the basis of the set values.

On the basis of the information input via the user interface unit 2, the internal parameter calculation unit calculates internal parameters for generating an ion trap control sequence using input information, past records, feedback information based on detected information, etc. by e.g., referring to the parameter storage unit 7 as needed.

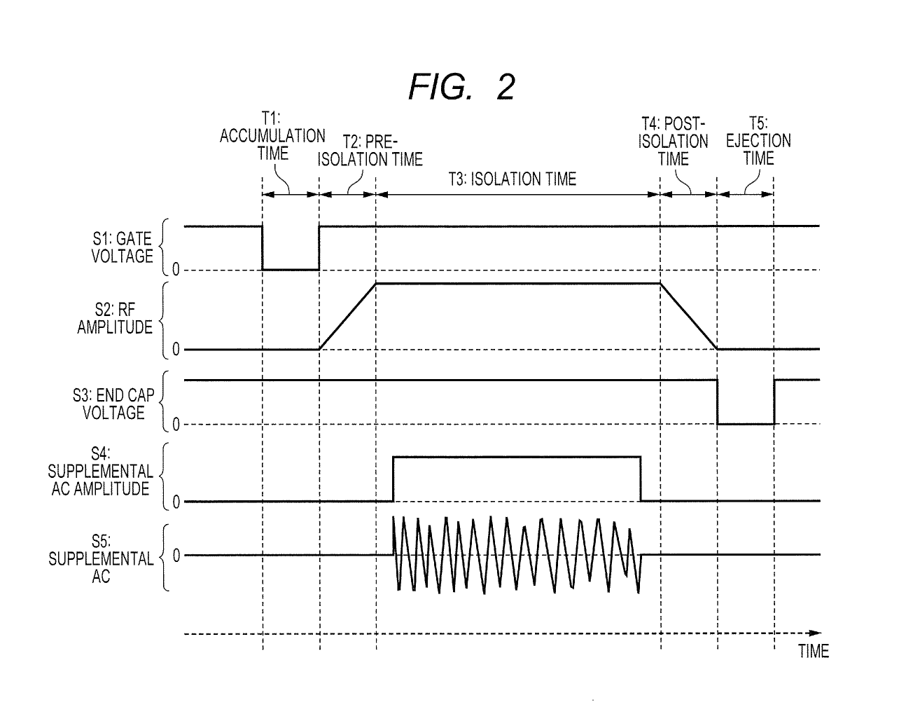

The control sequence preparation unit 5 calculates an ion trap control sequence with respect to time such as shown in FIG. 2 on the basis of the internal parameters calculated by the internal parameter calculation unit 4.

The control sequence execution unit 6 controls the AC circuit unit 8 and the DC circuit unit 9 on the basis of the ion trap control sequence generated by the control sequence preparation unit 5.

The parameter storage unit 7 stores previously set information, past records, and method for automatically calculating internal parameters that may be used when parameters are input.

The AC circuit unit 8 and the DC circuit unit 9 transmit signals to the ion trap unit 12 under the control of the control sequence execution unit 6.

The detector unit 13 detects ions ejected from the ion trap and transmits information about the detected ions to the control unit 3.

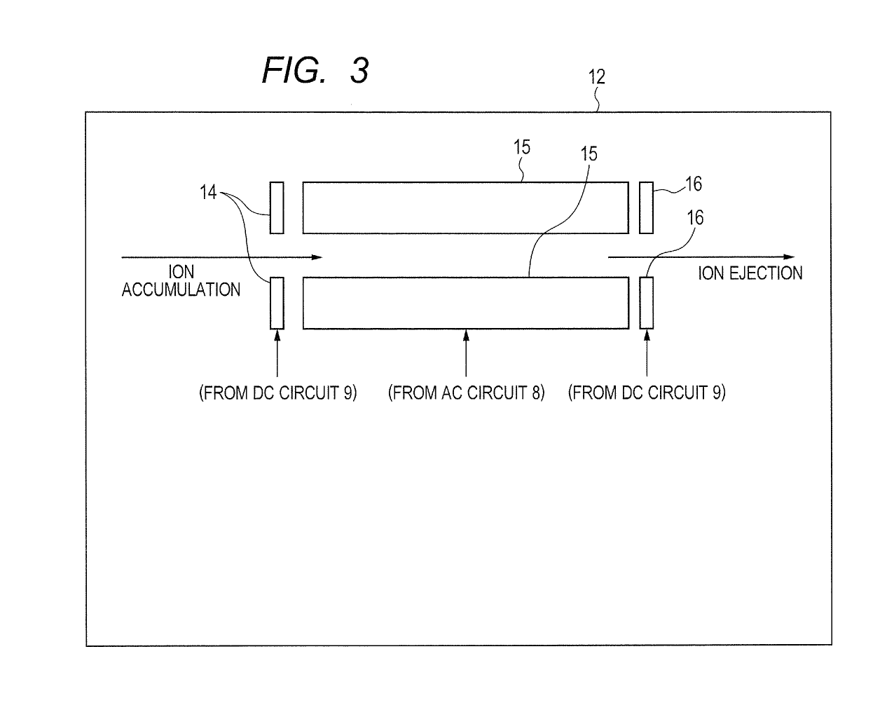

FIG. 3 shows an exemplary configuration of the ion trap in which a linear ion trap is used as the ion trap unit 12 of the mass spectrometer 1.

All the ions are introduced into a linear ion trap 15 via a gate 14. The ions are ejected out of the ion trap via an end cap 16 after necessary operations are performed in the linear ion trap 15.

The gate 14 controls the introduction of ions from outside the ion trap on the basis of signals from the DC circuit unit 9, while the end cap 16 controls the ejection of ions out of the ion trap on the basis of signals from the DC circuit unit 9.

The behavior of ions within the linear ion trap 15 is controlled by signals from the AC circuit unit 8. In this example, mass spectrometry is performed by an external device.

Although in this exemplary linear, ion trap, ions are introduced and ejected in the axial direction of the ion trap, the directions of introduction and ejection are not limited to the axial direction.

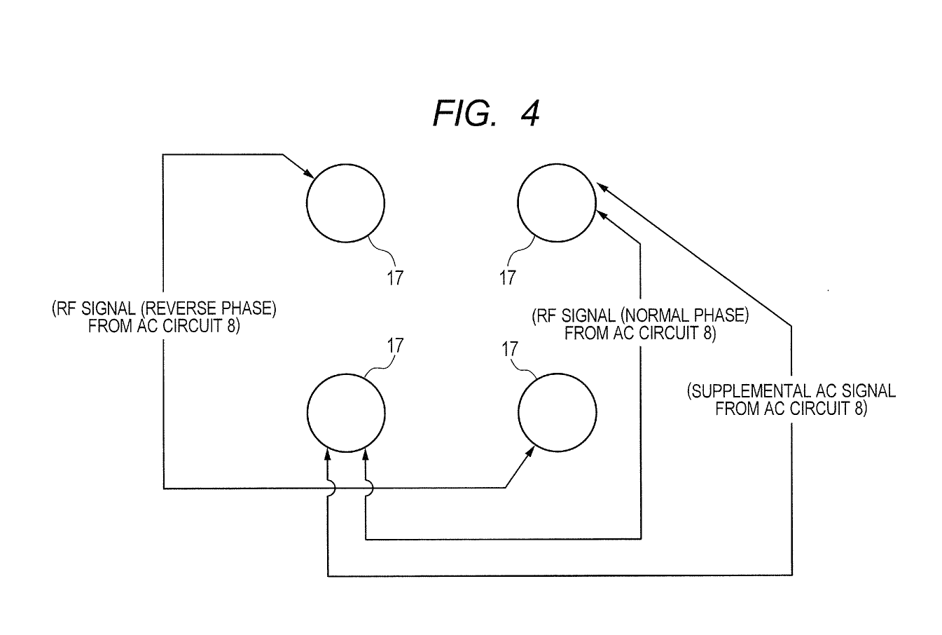

FIG. 4 shows the linear ion trap as viewed from the direction of ion introduction. Each of diagonal rod pairs facing each other constitute a set, and a combination of an Rf signal and a supplemental Rf signal is applied to one of the sets, while a reverse-phase Rf signal is applied to the other set.

Although the cross-units 17 of the linear ion trap are circular, any cross-sectional shape can be used as long as ions can be trapped using an Rf signal and resonance ejection can be performed using a supplemental Rf signal. Furthermore, the ion trap may have one or more apertures formed in the middle thereof for introduction and ejection of ions, and may also have additional devices attached for tandem mass spectrometry.

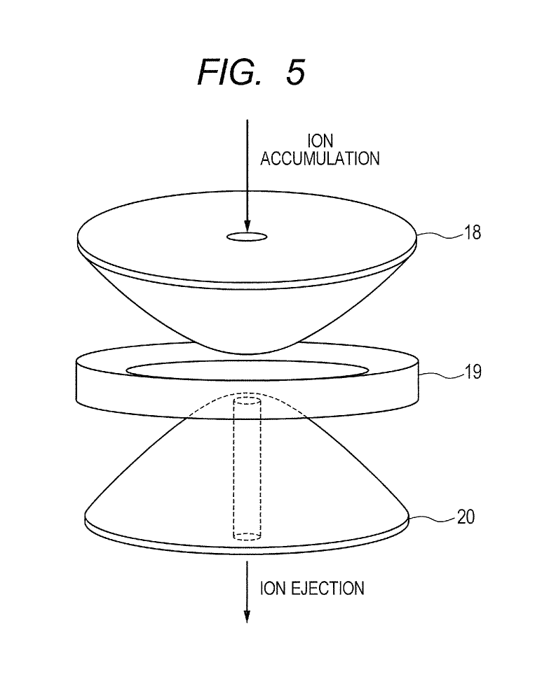

FIG. 5 shows the configuration of the ion trap in which a three dimensional quadrupole ion trap is used as the ion trap unit 12 of the mass spectrometer 1.

All ions are introduced via the center of an end cap A18, and are ejected via the center of an end cap B20 after necessary operations are performed in the ion trap formed by a ring electrode 19 and a space surrounded by the end cap B20.

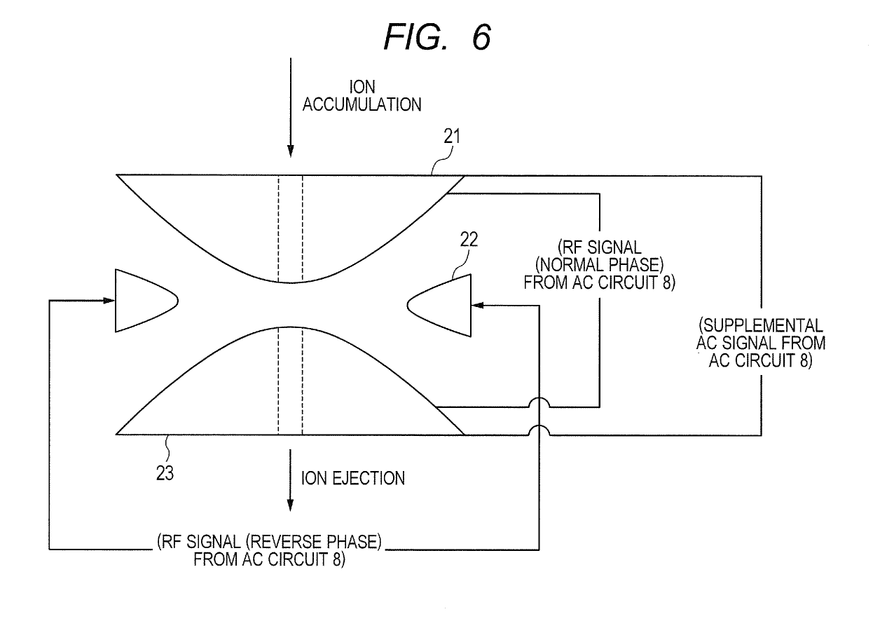

FIG. 6 is the cross-sectional diagram of the three dimensional quadrupole ion trap shown in FIG. 5. Although it differs in external shape, etc. from the linear ion trap, the trapping principle and the physical characteristics associated with values indicating the stability of trapped ions are identical.

The cross-unit 21 of the end cap A, the cross-unit 22 of the ring electrode, and the cross-unit 23 of the end cap B may take any cross-sectional shape as long as ions can be trapped using an Rf signal and resonance ejection can be performed using a supplemental Rf. Furthermore, the ion trap may have one or more apertures formed in the middle thereof for introduction and ejection of ions, and may also have additional devices attached for tandem mass spectrometry.

Specifically, various devices, such as a quadrupole mass filter, a TOF, an orbitrap, an FTICR, etc. may be connected to the ion trap and used to enable tandem mass spectrometry to be performed. Even in that case, the embodiments of the present invention can be used in a similar manner (see description referring to FIG. 3).

FIG. 2 is an exemplary control sequence generated by the control sequence preparation unit 5. The control sequence is generated with respect to time, and can be divided into several time segments, i.e., ion accumulation time T1, pre-isolation time T2, isolation time T3, post-isolation time T4, and ion ejection time T5.

The pre-isolation time T2 may be eliminated by reducing the time width to zero. The post-isolation time T4 may include a time required for performing tandem mass spectrometry, such as CID, and a time required for cooling the thermal energy given to ions. It is also possible to increase the measurement throughput by reducing the time width of the post-isolation time T4 to zero.

In FIG. 2, gate voltage S1 serves to control the introduction of ions at the inlet of the ion trap. Reducing this voltage introduces ions into the ion trap, while increasing this voltage halts the introduction of ions.

When ions are introduced, an appropriate accumulation time can be set taking into consideration the space charge effect inside the ion trap. That is, on the basis of the past records stored in the parameter storage unit 7 and feedback information such as the detected amount of ions obtained by the detector unit 13, the total amount of ions trapped inside the ion trap can be estimated in a real-time manner to set the accumulation time so that the space charge effect does not occur.

Rf voltage S2 controls the q-value of all the ions introduced into the ion trap, thereby controlling how the ions inside the ion trap are exposed to the supplemental Rf.

End cap voltage S3 serves to control the ejection of ions at the outlet of the ion trap. Reducing this voltage ejects ions out of the ion trap, while increasing this voltage halts the ejection of ions.

Supplemental Rf voltage S4 controls the exposure of ions inside the ion trap to the supplemental Rf during the isolation time T3. Supplemental Rf S5 is the supplemental Rf to which ions are actually exposed.

It is possible to learn how these steps S1 to S5 are performed in the mass spectrometer by using a device, such as an oscilloscope, to check signal lines connecting the control unit 3 to the AC circuit unit 8 and the DC circuit unit 9 and wiring connecting the AC circuit unit 8 and the DC circuit unit 9 to the mass spectrometer unit 10 in the mass spectrometer 1.

Since such signals are typically prepared at low voltages, and are then amplified with amplifiers to be transmitted to the ion trap, etc., the signal lines before amplified by the amplifiers may be checked in that case.

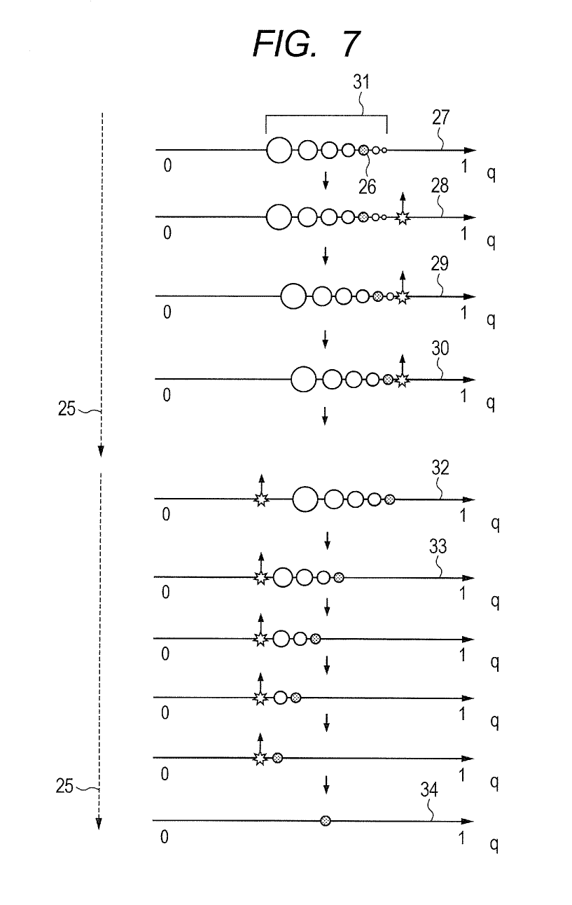

FIG. 7 is a schematic diagram showing the relationship between the supplemental Rf and ions inside the ion trap as the Rf voltage S2 is controlled. The time axis is denoted by reference number 25, while the precursor ions are denoted by reference number 26.

The higher the mass of ion is, the lower the q-value becomes, and the lower the mass of ion is, the higher the q-value becomes. In FIG. 7, circles respectively denote trapped ions 31, and the size of circle represents their magnitude of mass.

With respect to the trapped ions 27 before application of the supplemental Rf, the supplemental Rf is first set at a position spaced apart from the target precursor ions on the lower mass side thereof (28). A sweeping operation 29 is performed by gradually increasing the Rf voltage to sweep the q-value, thereby sequentially resonance-ejecting ions that come into resonance with the frequency set for the supplemental Rf (30).

In a similar manner, the supplemental Rf is then set at a position spaced apart from the target precursor ions on the higher mass side thereof (32), and the sweeping operation is performed by gradually reducing the Rf voltage to sweep the q-value, thereby sequentially resonance-ejecting the ions that come into resonance with the frequency set for the supplemental Rf (33). As a result, only the ions of interest are left from among the trapped ions (34).

In ion traps, a phenomenon referred to as the space charge effect is known to occur, in which the apparent mass is increased when an excessive amount of ions are introduced.

The occurrence of the space charge effect may prevent accurate isolation from being performed. However, performing isolation from the lower mass side as shown in FIG. 7 allows the number of ions inside the ion trap to be reduced before isolation is performed for the higher mass side, thus enabling the space charge effect to be reduced and therefore providing an advantage in that the adverse effects of the space charge effect can be avoided to perform isolation.

Although in this example, a supplemental Rf including only one frequency is used in the isolation process for both the lower and higher mass sides, the same principle can be basically applied even when frequencies for the lower and higher mass sides are combined, a plurality of frequencies are combined, or a broadband signal is used for either the lower mass side only or the higher mass side only, or for both of them.

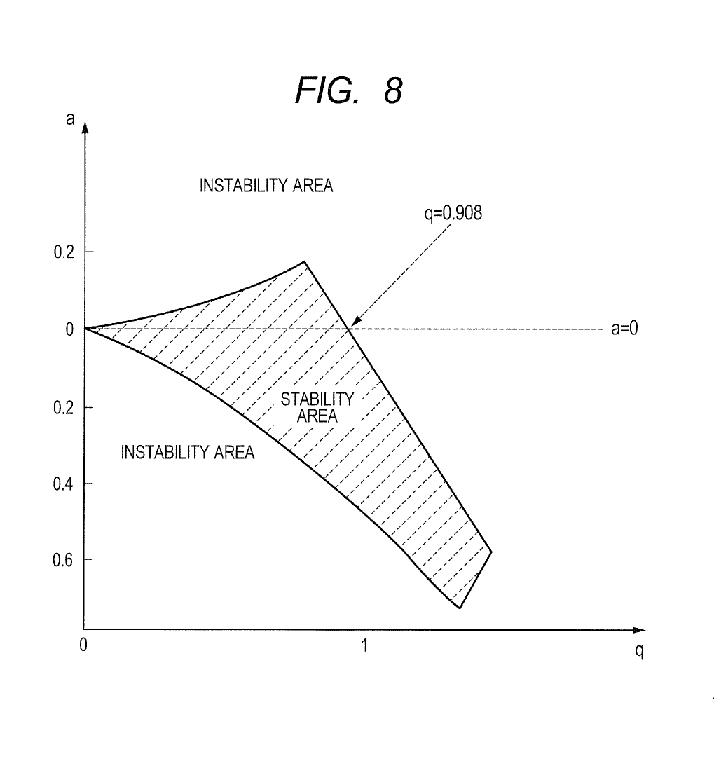

FIG. 8 shows the relationship between the q-value and the stability/instability of ions in an ion trap. Because in the present embodiment, the ion trap is used in a region of the diagram in which a=0, the q-value can take a value ranging from 0 to 0.908 as shown.

In addition: as can be understood from the definition of Expression 2, the fact that the q-value is relatively low on the higher mass side when compared to the lower mass side can be cited as an important characteristic.

Although in this embodiment, the case in which a=0 is described, the q-value can represent the stability of ions even when a≠0, and the same advantages of the invention can still be achieved in a similar manner by evaluating the q-value using a curve based on the a-value in that case.

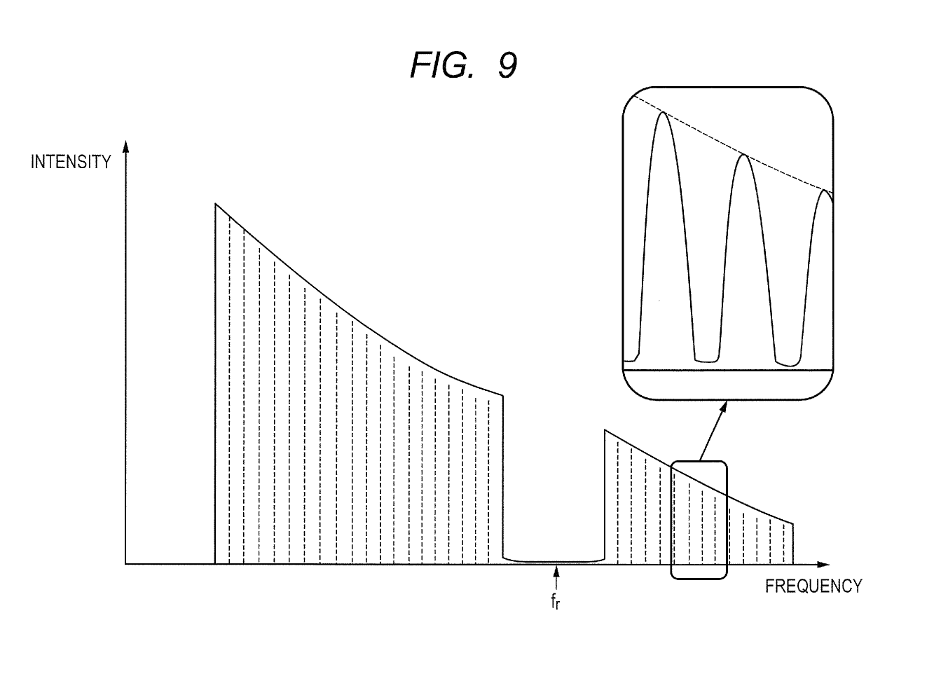

FIG. 9 shows an exemplary power spectrum of an FNF that is used as the supplemental Rf in the mass spectrometer 1. Although for the purpose of simplicity, the isolation shown in FIG. 7 is described as a single frequency being used as the supplemental Rf for both the lower and higher mass sides, a wide range sweeping operation is required in that case as described above. For this reason, in the present embodiment, an FNF is used to increase the isolation efficiency.

However, when such an approach using an FNF is found to adversely affect the precursor ions, a supplemental Rf obtained by combining one or more frequencies may also be used.

When the control sequence execution unit 6 included in the control unit 3 executes a control sequence such as shown in FIG. 2, the Rf voltage S2 is actually directly associated with the isolation operation such as described in FIG. 7.

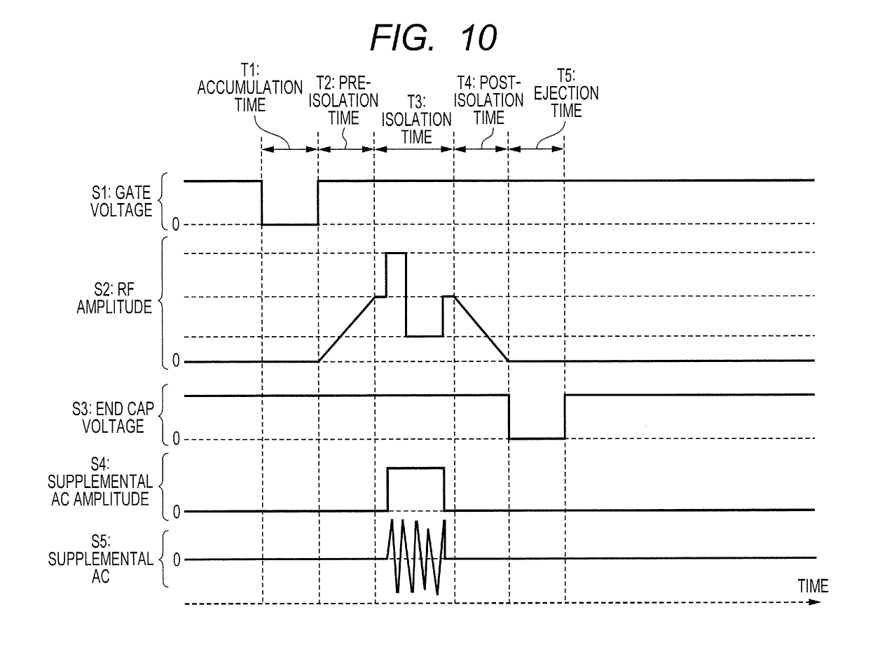

FIG. 10 shows an embodiment of the Rf voltage S2.

The Rf voltage may be not only a continuous function with respect to time but also a piecewise continuous function with respect to time. In addition, it may vary either linearly or nonlinearly with respect to time and may include both linear and nonlinear segments.

In this example, the supplemental Rf is brought into the proximity of the precursor ions in an instantaneous manner, and is kept in that state for a predetermined time. In order to increase the throughput, it is preferable that the length of time for which the supplemental Rf is kept constant be reduced as much as possible. However, uniformly reducing the isolation time in a simple manner may cause a problem in that isolation can be only performed insufficiently for the higher mass side when compared to the lower mass side.

For this reason, it may be necessary to increase the length of time for which the ions on the higher mass side are exposed to the supplemental Rf (exposure time) when compared to the lower mass side so that unnecessary ions are removed thoroughly, within a range that enables a required minimum scanning time to be set.

When sufficient resonance ejection is possible for the higher mass side, the length of time for the higher mass side may be the same as the lower mass side, and when no ions exist on the higher mass side, the length of time may be reduced to zero. Conversely, when the amount of ions on the lower mass side is high thus disabling sufficient resonance ejection from being performed, the length of time for the lower mass side may be increased, and when no ions exist on the lower mass side, the length of time for the lower mass side may be reduced to zero.

As the supplemental Rf, it is also possible to use a broadband signal for both the lower and higher mass sides, and when sufficient resonance ejection is possible, such as when the number of ion species is low, a combination of one or more frequencies may be used for either the lower mass side only or the higher mass side only, or for both of them.

Although the present example can address the problem that resonance ejection is less likely to be performed for the higher mass side, when an FNF is used, a gap is actually generated between any two adjacent frequency components as shown in an enlarged manner in FIG. 9, and as a result, there may be caused a problem in which isolation can be performed only insufficiently for a sample including ions that correspond to such gaps.

However, when such a problem does not occur, this approach has an advantage in that the isolation time can be reduced substantially, e.g., it can be reduced even to about 1 ms.

Before and after the isolation, there is provided a time zone in which the supplemental Rf is not applied. This particularly has an advantage in that the thermal energy of ions after the isolation is reduced, thereby enabling the ions to be stabilized and unintended dissociation of the ions to be prevented.

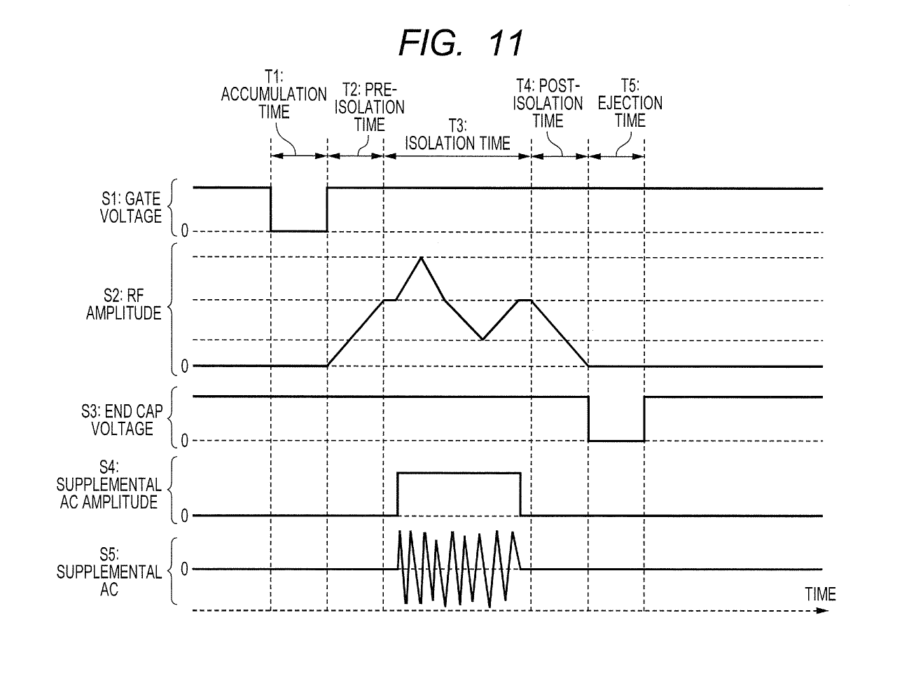

FIG. 11 shows another embodiment of the Rf voltage S2. This example can prevent the insufficient isolation due to the gaps of an FNF such as shown in an enlarged manner in FIG. 9 by sweeping the Rf voltage.

Furthermore, by adjusting the width and gradient of the sweeping operation during isolation, it is possible to secure a longer sweeping time for the higher mass side than the lower mass side, thus enabling the exposure time to the supplemental Rf to be increased for the higher mass side. As a result, the problem that resonance ejection is less likely to be performed for the higher mass side can also be addressed as in the example shown in FIG. 10.

When sufficient resonance ejection is possible for the higher mass side, the length of time for the higher mass side may be the same as the lower mass side, and when no ions exist on the higher mass side, the length of time may be reduced to zero. Conversely, when the amount of ions on the lower mass side is high thus disabling sufficient resonance ejection from being performed, the length of time for the lower mass side may be increased, and when no ions exist on the lower mass side, the length of time for the lower mass side may be reduced to zero.

As the supplemental Rf, a broadband signal may be used for both the lower and higher mass sides, and when sufficient resonance ejection is possible, such as when the number of ion species is low, a combination of one or more frequencies may be used for either the lower mass side or the higher mass side, or for both of them.

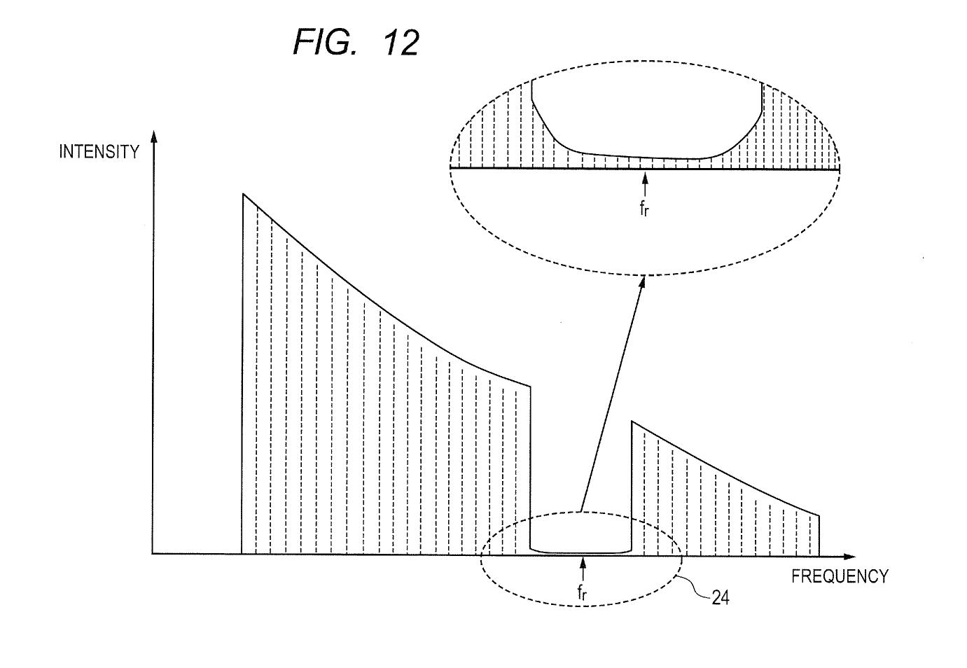

FIG. 12 shows an exemplary FNF waveform. Frequency window 24 in which the FNF frequency components are reduced is shown in an enlarged manner in this figure. As shown, due to the principle on which the FNF is generated, the frequency components within the frequency window 24 actually cannot be reduced to zero and still remain though their amounts are very low.

For this reason, in contrast with ions that are less likely to be dissociated, such as reserpine, instable ions, such as glycosylated peptides and protonated molecules of some low molecular weight compounds, may be resonance-ejected by such frequency components remaining in trace amounts or may be dissociated by the thermal energy, thus resulting in the number of the ions being reduced.

In particular, in portions close to the upper and lower edges of the frequency window, the signal intensity of the frequency components is higher than the central portion of the frequency window. Therefore, keeping the edge portions close to the target precursor ions for a long time may cause the precursor ions to be resonance-ejected or dissociated.

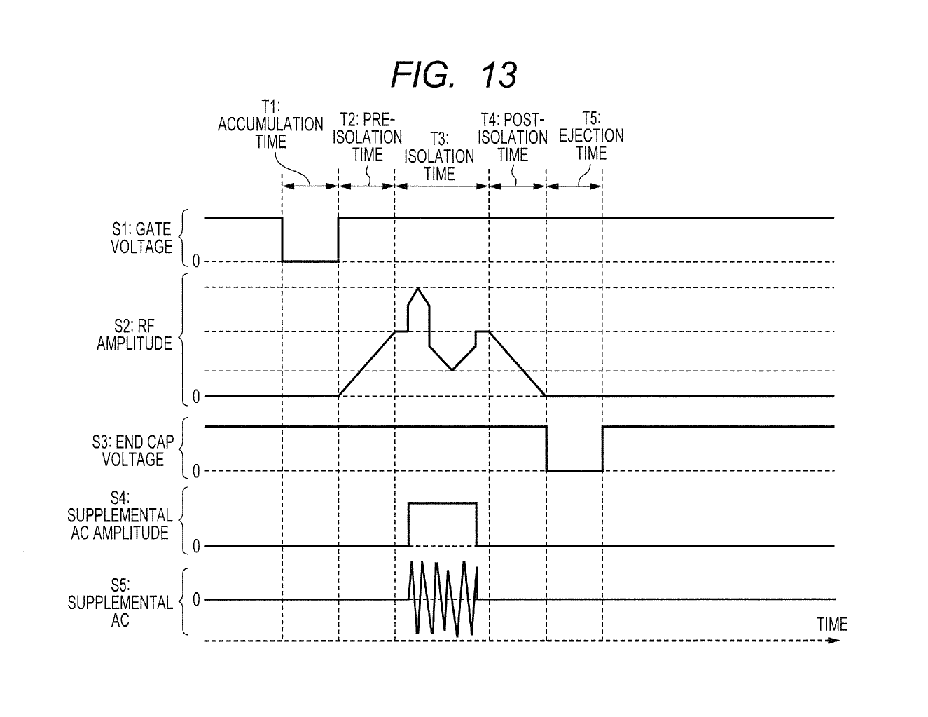

FIG. 13 shows still another embodiment of the Rf voltage S2. When compared to FIG. 11, this example first brings the supplemental Rf closer to the precursor ions at once in a portion of the sweeping range so as to shorten the isolation time and then scans it in another portion so that ions other than the precursor ions can be thoroughly resonance-ejected. Furthermore, this example also addresses the problem that resonance ejection is less likely to occur on the higher mass side because the q-value is low by scanning a relatively wider range on the high mass side for a longer time than the lower mass side. That is, setting the length of time required for isolation short makes it difficult to evenly allocate the length of time required for isolation to the higher and lower mass sides of the precursor ions. This is because the even allocation of time may cause incomplete removal of ions on the higher mass side. The cause of this phenomenon can be explained as follows. That is, the secular motion of ions can be considered as a harmonic oscillator. Therefore, when the q-value is reduced, the potential depth P of the oscillation motion is also reduced on the basis of the following relationship (Expression 4).

$$P ∝ \frac{{e ( {V}_{RF} )}^{2}}{{m}_{z} {{r}^{2} ( 2 π F )}^{2}} = \frac{{qV}_{RF}}{4} \qquad Expression 4$$

Actually, performing the scanning operation in this manner enables the required length of time to be reduced; sufficient isolation efficiency and increased sensitivity for weak ions can be achieved in a length of time of about 5 ms.

As an exemplary sample that imitates samples actually analyzed in the field, there was prepared a sample in which reserpine (unlikely to be lost), Substance P (RPKPQQFFGLM) (very likely to be lost), and a mass marker (Ultramark) (likely to be lost) are mixed taking into consideration the extent to which they are lost during isolation.

This is because some of samples actually analyzed in the field may be unlikely to be lost during isolation but others may be likely to be lost depending on the molecules included therein, and the above sample was prepared to reproduce such a situation. In addition, for ease of the experimental reproduction, the above sample was prepared using materials that are commonly distributed and easily available.

In general, some of biomolecules, such as peptides and post-translationally modified peptides, are known to have different likelihoods of being lost during mass spectrometry. From among the above three materials, Substance P having an amino acid sequence of RPKPQQFFGLM can be considered to represent molecules that are likely to be lost. When isolation is performed, the reduction of survival rate of molecules other than the molecules to be isolated may be sometimes considered important to achieve accurate analysis, but in other cases, the sensitivity for the molecules to be isolated may be considered more important than the survival rate reduction of molecules other than the molecules to be isolated. Therefore, it is necessary to modify the parameters for isolation so as to suit the specific purpose.

Typically, for analysis such as MS/MS and MS/MS/MS, it is important to reduce the survival rate of the other molecules to zero percent because they may affect the analytical result if they survive the isolation. In contrast, when the molecules to be isolated are likely to be lost during isolation, the other molecules may be allowed to survive to some extent so that the survival rate of the molecules to be isolated can be increased so as to increase the sensitivity.

Focusing on the sweeping time for the higher mass side when compared to the lower mass side as an isolation parameter, setting the sweeping time for the higher mass side at 1.2 times the sweeping time for the lower mass side enables the survival rate of molecules other than the molecules to be isolated to be suppressed to 20% or less when each of the three molecular species is isolated.

In order to reduce the survival rate of the molecules other than molecules to be isolated to zero percent, it was necessary to set the sweeping time for the higher mass side at 1.4 times the sweeping time for the lower mass side.

The above condition, i.e., the condition with which the survival rate of molecules other than the molecules to be isolated can be reduced to zero percent, may be set and commonly used as one of normal measurement modes.

For Substance P (RPKPQQFFGLM) representing molecules that are likely to be lost, it is possible to increase the ion survival rate by setting the sweeping time for the higher mass side at a value lower than 1.4 times the sweeping time for the lower mass side so as to increase the survival rate of the molecules to be isolated so that the sensitivity is increased, even though the other molecules may be also allowed to remain to some extent. More specifically, focusing on the divalent ions (674.86) of Substance P (RPKPQQFFGLM), while the survival rate was 30% for the above setting of 1.4 times, setting the sweeping time for the higher mass side at 1.2 times the sweeping time for the lower mass side not only increased the survival rate of the neighboring ions (685.90) to about 20% but also increased the survival rate of the divalent ions of Substance P (RPKPQQFFGLM) to 70%. Therefore, this setting is advantageous for soft ions, i.e., ions that are likely to be lost.

For reserpine, even if the sweeping time for the higher mass side is set at two times the sweeping time for the lower mass side, the survival rate of reserpine itself could be kept at 99%. Therefore, this setting is advantageous when the isolation capability is preferred.

In theory, it is also possible to set the sweeping time for the higher mass side at any value higher than two times the sweeping time for the lower mass side. For example, it is even possible to perform the sweeping operation for a length of time required for completely removing ions existing on the higher mass side if no consideration needs to be given to the throughput. However, portions of the device configuration other than the ion trap may sometimes impose constraints. In the present embodiment, the overall isolation time width is limited to 100 ms, taking into consideration MS/MS analysis by the following ECD and timing adjustment for tandem mass spectrometry by TOF. As a result, the sweeping time for the higher mass side is limited to being equal to or less than 50 times the sweeping time for the lower mass side. This means that if the sweeping time for the higher mass side is set at 50 times the sweeping time for the lower mass side and a sweeping operation of about 2 ms is performed for the lower mass side, the overall isolation time width becomes about 100 ms.

For a sample including ions having more or less the same likelihood of being affected during isolation, i.e., of being lost during isolation, it is possible to increase the sensitivity by modifying the sweeping time setting so as to suit the sample.

As the supplemental RF, a broadband signal may be used for both the lower and higher mass sides, and when sufficient resonance ejection is possible, such as when the number of ion species is low, a combination of one or more frequencies may be used for either the lower mass side or the higher mass side, or for both of them.

Here, the Rf voltage shown in FIG. 13 may be achieved by applying it as follows. That is, the RF voltage may be applied such that the Rf voltage has an extreme value both on the lower and higher mass sides, the Rf voltage has a plurality of different gradients between the trapping voltage and the extreme values, and the magnitude of a gradient from among the plurality of different gradients close to an extreme value is lower than the magnitude of a gradient from among the plurality of different gradients away from the extreme value.

As another example, the RF voltage may also be achieved as follows. That is, when isolation is performed on the lower mass side, the RF voltage has a maximum value, the differential coefficient of a curve followed by the RF voltage with respect to time before the RF voltage reaches the maximum value is always positive or zero except for breakpoints, and the differential coefficient of the curve followed by the RF voltage with respect to time after the RF voltage reaches the maximum value is always negative or zero except for breakpoints, and when isolation is performed on the higher mass side, the RF voltage has a minimum value, the differential coefficient of a curve followed by the RF voltage with respect to time before the RF voltage reaches the minimum value is always negative or zero except for breakpoints, and the differential coefficient of the curve followed by the RF voltage with respect to time after the RF voltage reaches the minimum value is always positive or zero except for breakpoints.

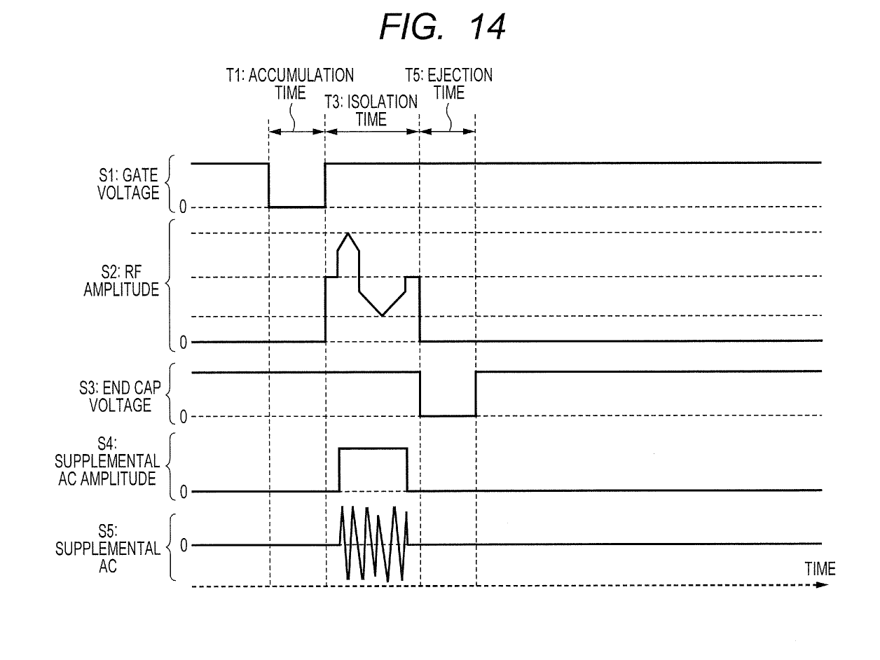

FIG. 14 show an example in which the widths of the pre-isolation time and the post-isolation time are reduced to zero in FIG. 13.

As a result, although the Rf voltage is changed abruptly after the introduction of ions and the q-value of ions is also abruptly changed accordingly, the stability of ions is not affected even in that case.

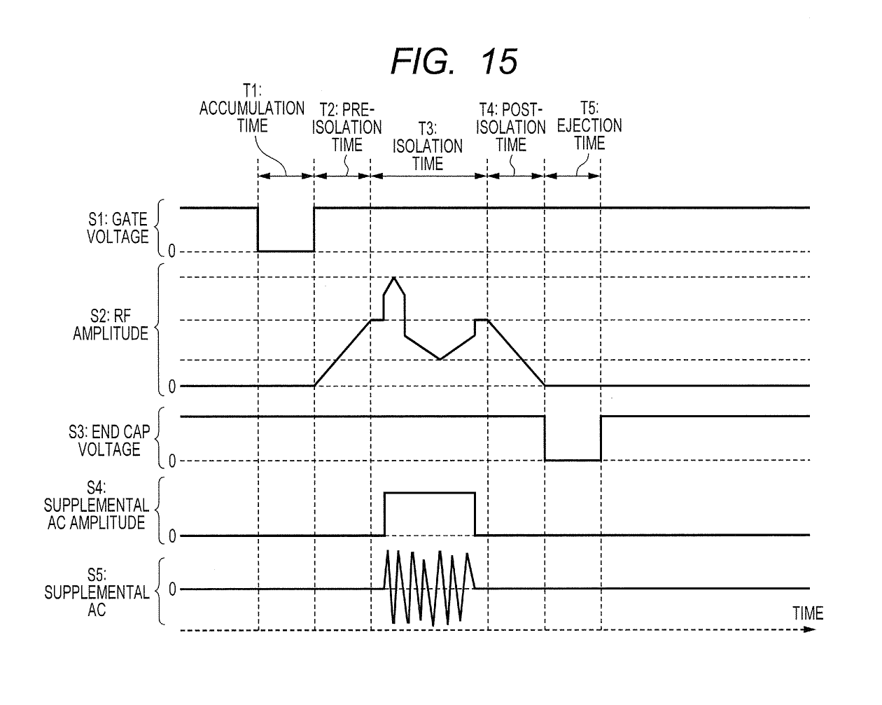

FIG. 15 shows an example in which in the parameter setting in FIG. 13, the sweeping gradients for the higher mass side are reduced.

In this case, although more time is consumed than FIG. 13, the exposure time to the supplemental Rf is increased. As a result, it is possible to address the case in which resonance ejection is less likely to occur on the higher mass side, and the required time can also be reduced to a minimum level by adjusting the gradients.

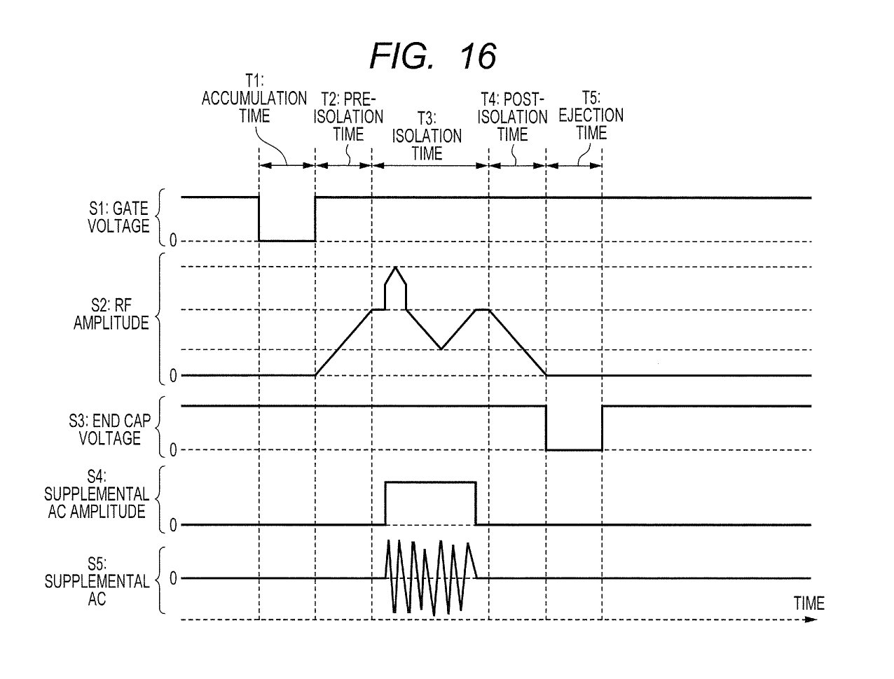

FIG. 16 shows an example in which in the parameter setting in FIG. 15, the distance along which the higher mass side is brought close to the Rf voltage is reduced to zero and the sweeping range is increased instead.

This example is advantageous for the case in which when an FNF is used as the supplemental Rf, ions are left at several regions because the scanning range is insufficient.

As in FIG. 13, this example can also address the problem that resonance ejection is less likely to occur on the higher mass side by increasing the sweeping range without the distance along which the higher mass side is brought close to the supplemental Rf reduced to zero. This is because increasing the sweeping range without the distance along which the higher mass side is brought close to the supplemental Rf reduced to zero results in the exposure time to the supplemental Rf being increased.

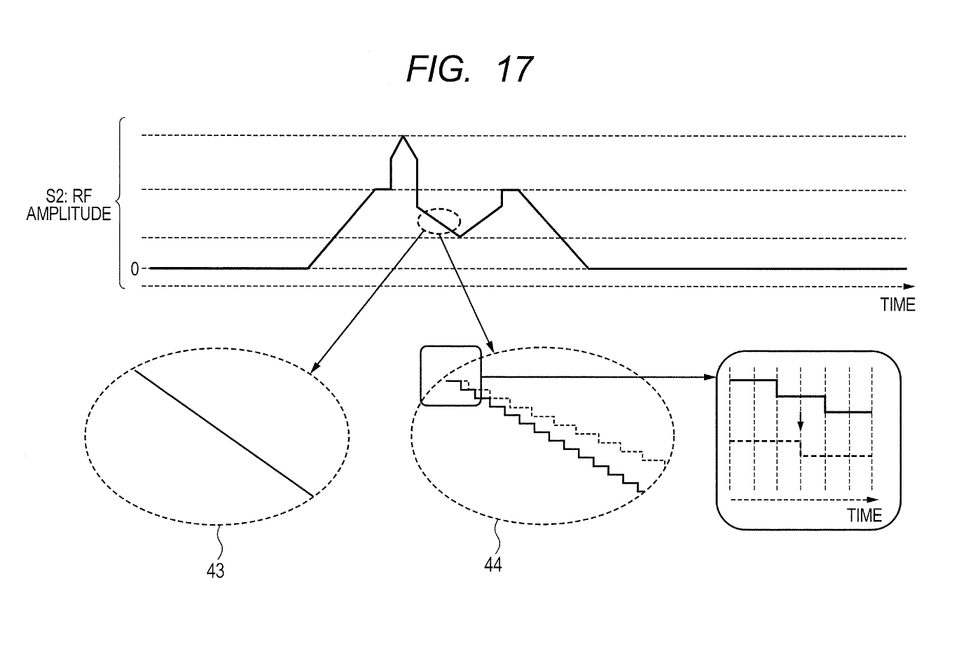

FIG. 17 is a diagram showing the differences between methods for generating a voltage control waveform that is used in the sweeping operation. When it is achieved by an analog circuit (43), the voltage varies in a continuous manner, while when it is achieved by a digital circuit (44), the voltage varies in a stepwise manner due to the limitation of voltage resolution imposed by the principle thereof. For this reason, in a digital circuit, setting the length of the duration of each step determines the gradient of the sweeping voltage. A line such as shown in the present embodiment needs to be obtained by e.g., approximating the changes in potential as a smooth function.

Furthermore, using the fact that each potential is maintained for a predetermined time, it is also possible to perform resonance ejection in an effective manner by calculating the length of time corresponding to one period of the frequency used for the resonance ejection and setting the duration on the basis of the calculation result. In practice, it is possible to achieve sufficient resonance ejection by setting the duration of each potential so as to correspond to a length of time of about 4 to 5 times one period.

As the supplemental Rf, a broadband signal may be used for both the lower and higher mass sides, and when sufficient resonance ejection is possible, such as when the number of ion species is low, a combination of one or more frequencies may be used for either the lower mass side or the higher mass side, or for both of them.

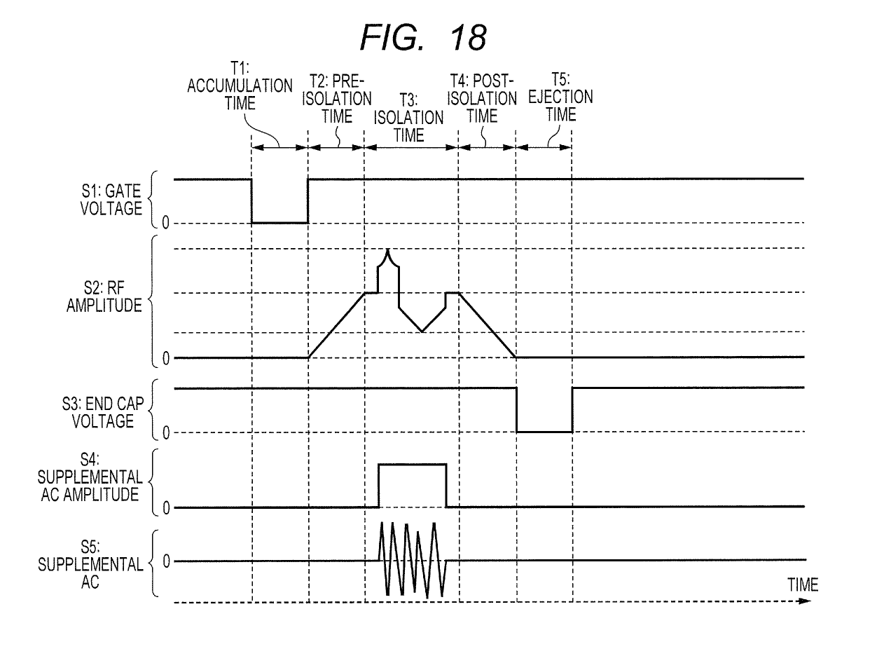

FIG. 18 shows an example in which a function for the Rf voltage S2 is set via the user interface unit 2 so as to be applied to the lower mass side. The function may be set by using a mathematical function of time or a table representing the relationship between the voltage and time.

In the present example, the manner in which the supplemental Rf is brought close to precursor ions on the lower mass side is modified so that not only the length of time for which the supplemental Rf is positioned close to the precursor ions can be reduced as much as possible but also the necessary range can be still scanned.

As the supplemental Rf, a broadband signal may be used for both the lower and higher mass sides, and when sufficient resonance ejection is possible, such as when the number of ion species is low, a combination of one or more frequencies may be used for either the lower mass side or the higher mass side, or for both of them.

In this case, the RF voltage may be applied as follows. That is, the RF voltage may be applied so that the RF voltage has an extreme value with respect to time, the RF voltage varies nonlinearly with respect to time, and the rate of change of the RF voltage is increased as it approaches the extreme value.

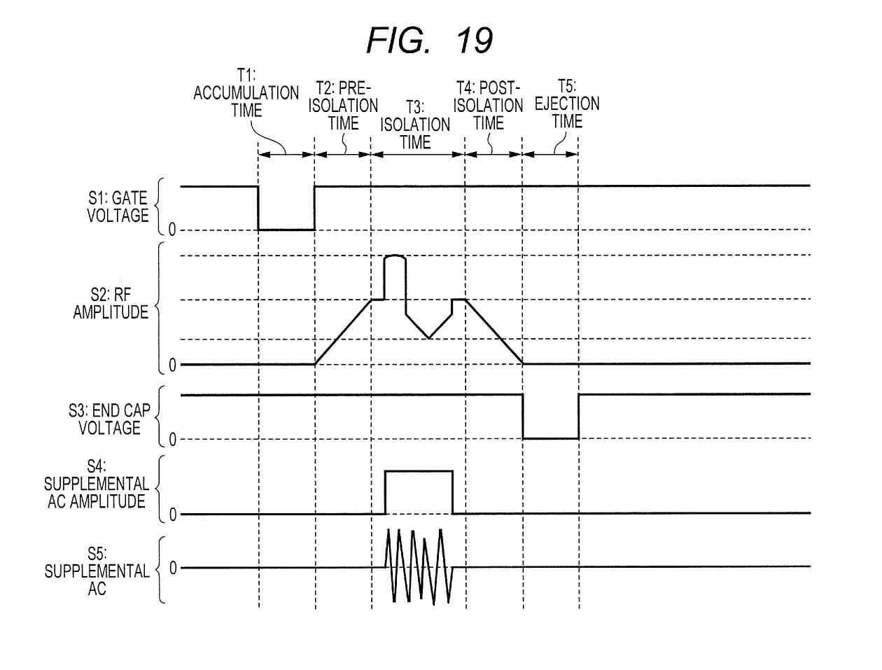

FIG. 19 shows an example in which another function is set for the Rf voltage S2 via the user interface 2 so as to be applied to the lower mass side.

In this example, it is possible to sufficiently remove the other ions present immediately close to the precursor ions on the lower mass side by bringing the supplemental Rf close to the precursor ions and making the sweeping gradient more moderate. As a result, accurate tandem mass spectrometry can be performed after the isolation.

As the supplemental Rf, a broadband signal may be used for both the lower and higher mass sides, and when sufficient resonance ejection is possible, such as when the number of ion species is low, a combination of one or more frequencies may be used for either the lower mass side or the higher mass side, or for both of them.

In this case, the RF voltage may be applied as follows. That is, the RF voltage may be applied so that the RF voltage has an extreme value with respect to time, the RF voltage varies nonlinearly with respect to time, and the rate of change of the RF voltage is reduced as it approaches the extreme value.

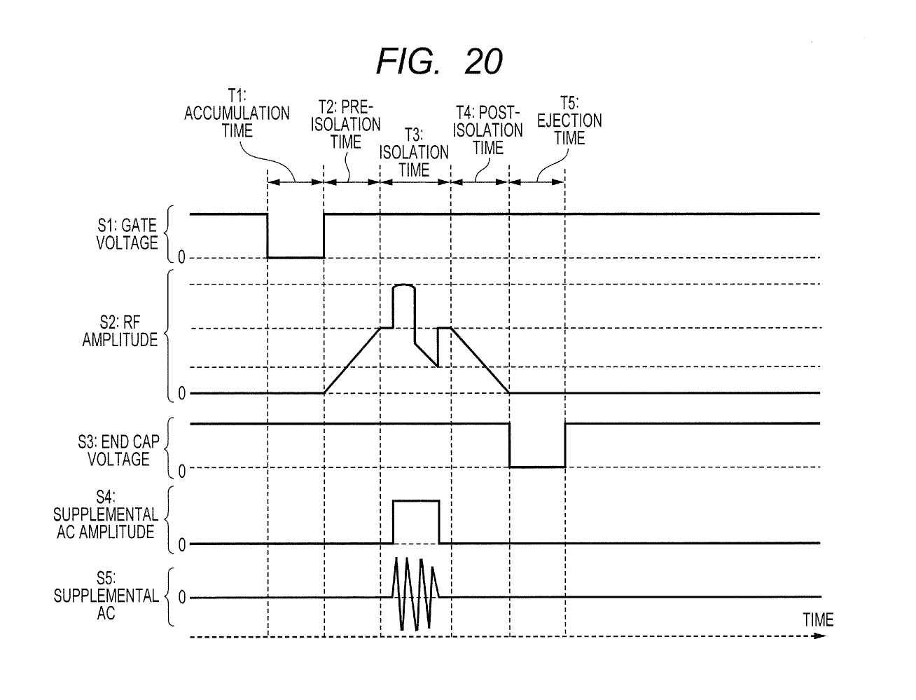

FIG. 20 shows an example in which the scanning operation on the higher mass side is performed only in the direction from relatively higher to relatively lower q-value in the example shown in FIG. 19. In this case, because isolation can be performed sufficiently for the higher mass side, performing the setting in this manner to reduce the isolation time prevents reduction in the number of precursor ions, thus enabling not only the sensitivity but also the measurement throughput to be increased.

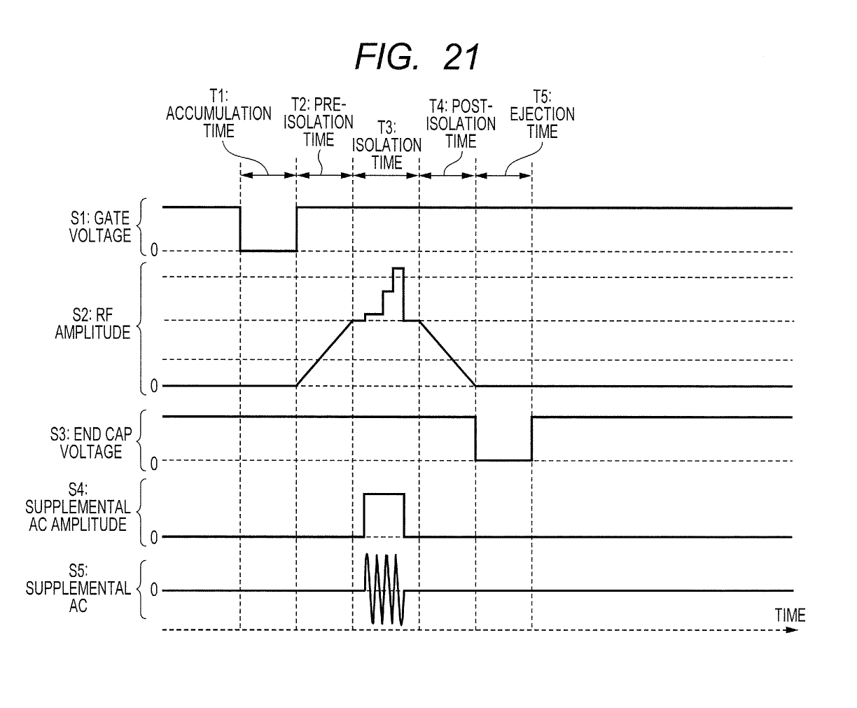

FIG. 21 shows an example in which other than the ion species of interest, there exist two ion species on the lower mass side and one ion species on the higher mass side, and the supplemental Rf is set via the user interface unit 2 so that the supplemental Rf includes only one frequency and is initially located at a position in which the q-value is higher than the two ion species on the lower mass side.

From among the two ion species on the lower mass side, the ion species that is away from the ion species of interest has a large amount of ions, and therefore, they are exposed to the supplemental Rf for a relatively long time. In contrast, the ion species on the lower mass side that is close to the ion species of interest and the ion species on the higher mass side are substantially the same in quantity, and because the supplemental Rf is fixed, the q-values for these two species are the same during resonance ejection. Therefore, the same exposure time is used for both of these two species.

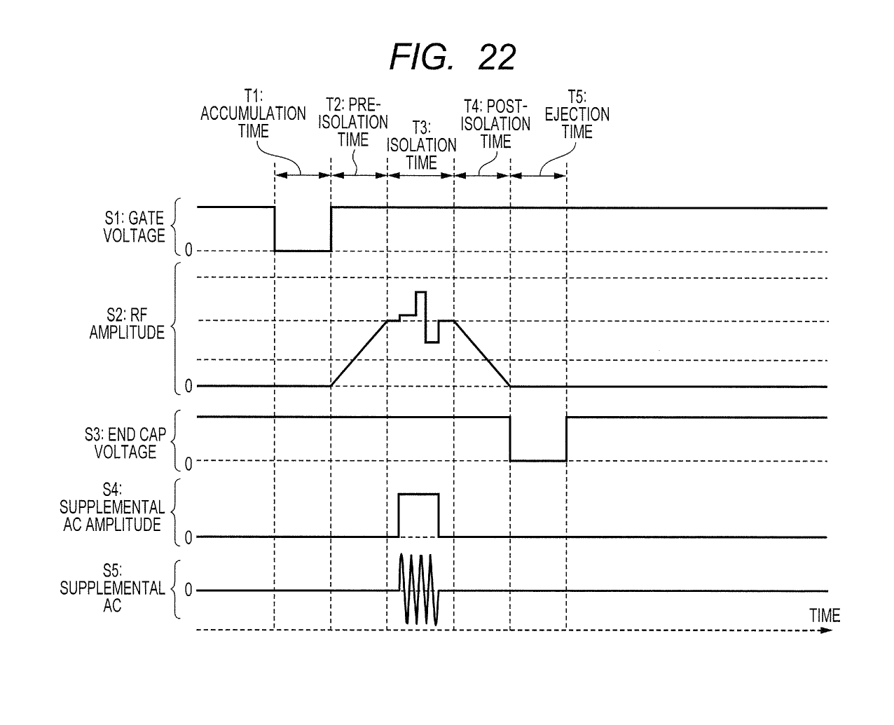

FIG. 22 shows an example in which other than the ion species of interest, there exist two ion species on the lower mass side and one ion species on the higher mass side, and the supplemental Rf is set via the user interface unit 2 so that the supplemental Rf initially has one frequency at a position in which the q-value is higher than the two ion species on the lower mass side and one frequency at a position in which the q-value is lower than the ion species on the higher mass side.

From among the two ion species on the lower mass side, the ion species that is away from the ion species of interest has a large amount of ions, and therefore, they are exposed to the supplemental Rf for a relatively long time. On the other hand, although the ion species on the lower mass side that is close to the ion species of interest and the ion species on the higher mass side are substantially the same in quantity, the q-value during resonance ejection is lower on the higher mass side. Therefore, the exposure time is set longer for the higher mass side.

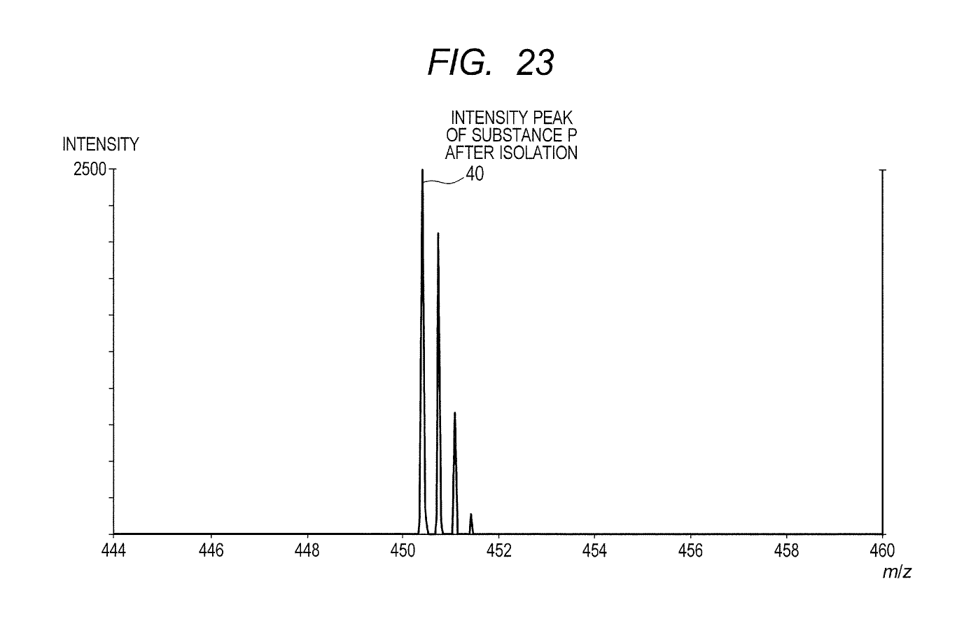

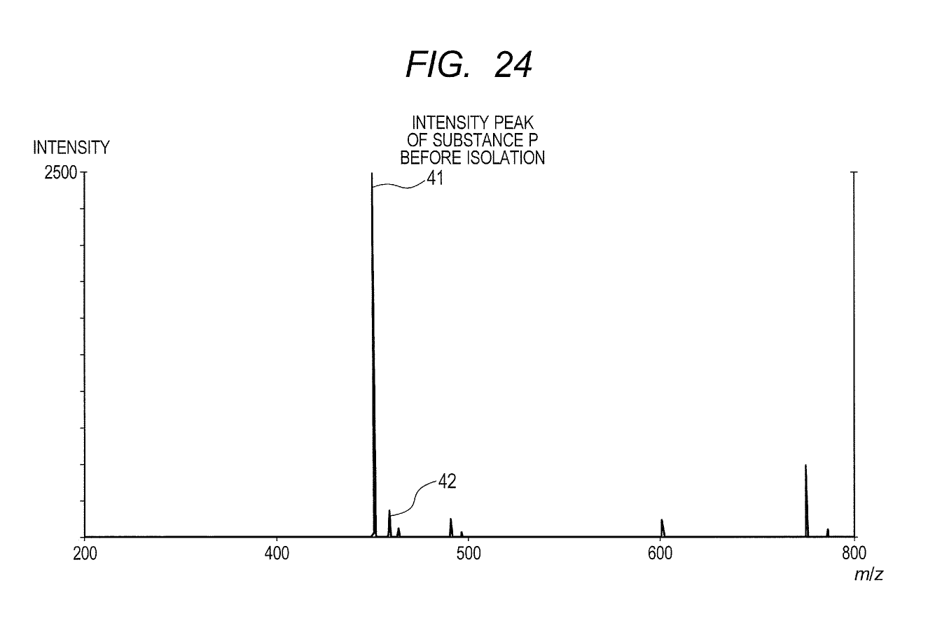

FIG. 23 shown an exemplary spectrum detected by the detector unit 13 when Substance P (RPKPQQFFGLM) was isolated by adjusting the parameters via the user interface unit 2 so that a control sequence corresponding to the control sequence shown in FIG. 14 in the present embodiment is executed. Peak 40 shows Substance P (450.4, 3+, ion intensity: 2538). In addition, FIG. 24 shows an exemplary spectrum detected by the detector unit 13 immediately before the isolation showed in FIG. 23 was performed. Here, Peak 41 shows Substance P (450.4, 3+, ion intensity: 2624).

Substance P (RPKPQQFFGLM) is ion species that is relatively likely to be dissociated. However, the ratio of ion intensity between FIG. 23 and FIG. 23 reveals that the method of the invention enabled 96% of the ions present before the isolation to survive the isolation.

Furthermore, another ion species 24 shown in FIG. 24 has an m/z of 458.4, and its absence in FIG. 23 shows that ions other than Substance P (RPKPQQFFGLM) have been removed.

In view of the fact that 99% of reserpine, i.e., ions less likely to be dissociated, could survive the isolation, it can be understood that a similar level of isolation efficiency was achieved also for ions that are likely to be dissociated.

The specific parameters set for measuring Substance P (RPKPQQFFGLM) were as follows. The m/z of the precursor ions was 450.4, the valence was 3, an FNF was used as the supplemental Rf, the width of the frequency window was a total of 40 Da, i.e., 20 Da on the lower mass side and 20 Da on the higher mass side, the sweeping operation was performed in Mode 1, and the sweeping parameters were such that on the lower mass side, the sweeping operation is performed up to a position that is 1.7 Da away from the precursor ions and the gradient of the Rf voltage is set so that the sweeping width is 5 Da, and on the higher mass side, the sweeping operation is performed up to a position that is 3 Da away from the precursor ions and the gradient of the Rf voltage is set so that the sweeping width is 7 Da.

In the present embodiment, the Rf voltage is controlled digitally. The time width for which each potential is maintained is 12 micro seconds. As the resonance frequency is at about 400 kHz, this time width may correspond to 4 or 5 times the period of an oscillation motion having such a frequency. The ratio of sweeping width between the higher mass side and the lower mass side corresponds to the ratio of sweeping time between them. This is because the sweeping operation is performed in a stepwise manner on the basis of a fixed, uniform time width. As a result, the sweeping time for the higher mass side is 1.4 times the sweeping time for the lower mass side in this case. The above described parameters achieved an overall isolation time of about 5 ms.

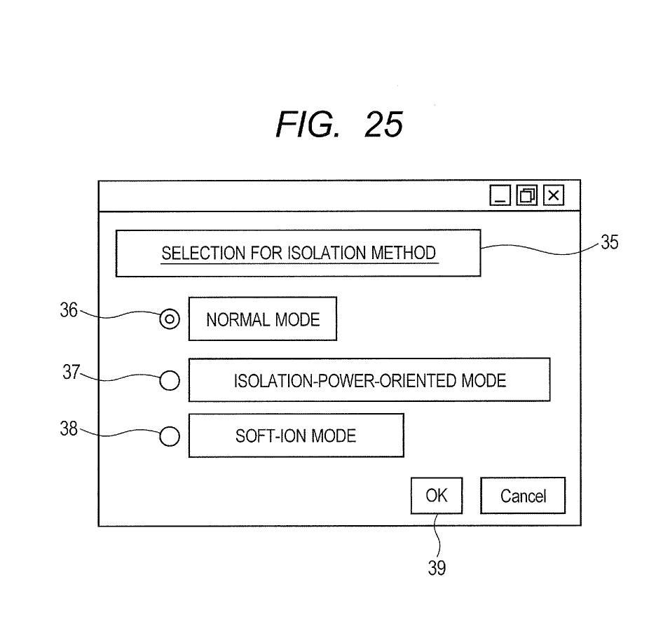

As shown in FIG. 25, it is also possible to allow the user to easily select the isolation efficiency and the overall isolation time by displaying on the user interface unit 2 a plurality of previously prepared sets of a higher mass side sweeping time and a lower mass side sweeping time. Here, as an example, title 35, i.e., SELECTION FOR ISOLATION METHOD, is displayed together with three choices for operation mode, i.e., NORMAL MODE 36 in which the sweeping time for the higher mass side is set higher than the sweeping time for the lower mass side, ISOLATION-POWER-ORIENTED MODE 37 in which the sweeping time for the higher mass side is set even higher than Normal MODE, and SOFT-ION MODE 28 in which the sweeping width is set small so as to increase the survival rate of the ions to be analyzed. Selecting one of the modes and pushing the OK button enables isolation to be performed in an appropriately selected mode as needed.

### LIST OF REFERENCE SIGNS

1 MASS SPECTROMETRIC ANALYZER
2 USER INTERFACE UNIT
3 CONTROL UNIT
4 INTERNAL PARAMETER CALCULATION UNIT
5 CONTROL SEQUENCE PREPARATION UNIT
6 CONTROL SEQUENCE EXECUTION UNIT
7 PARAMETER STORAGE UNIT
8 AC CIRCUIT UNIT
9 DC CIRCUIT UNIT
10 MASS SPECTROMETER UNIT
11 ION SOURCE UNIT
12 ION TRAP UNIT
13 DETECTOR UNIT
14 GATE UNIT
15 LINEAR ION TRAP UNIT
16 END CAP UNIT
17 CROSS UNIT OF LINEAR ION TRAP
18 END CAP UNIT A
19 RING ELECTRODE UNIT
20 END CAP UNIT B
21 CROSS UNIT OF END CAP UNIT A
22 CROSS UNIT OF RING ELECTRODE UNIT
23 CROSS UNIT OF END CAP UNIT B
24 FREQUENCY WINDOW
25 TIME COURSE
26 PRECURSOR IONS
27 SCHEMATIC VIEW OF TRAPPED IONS ON Q-VALUE AXIS BEFORE APPLYING SUPPLEMENTAL AC
28 SCHEMATIC VIEW OF TRAPPED IONS ON Q-VALUE AXIS DURING APPLYING SUPPLEMENTAL AC TO LOW MASS SIDE OF IONS
29 SCHEMATIC VIEW OF TRAPPED IONS ON Q-VALUE AXIS DURING APPLYING SUPPLEMENTAL AC TO LOW MASS SIDE OF IONS AND INCREASING AMPLITUDE OF TRAP RF TO INCREASE Q-VALUES OF IONS
30 SCHEMATIC VIEW OF TRAPPED IONS BEING EJECTED SEQUENTIALLY FROM LOW MASS SIDE BY THE RESONANCE EFFECT OF SUPPLEMENTAL AC
31 TRAPPED IONS
32 SCHEMATIC VIEW OF TRAPPED IONS ON Q-VALUE AXIS DURING APPLYING SUPPLEMENTAL AC TO HIGH MASS SIDE OF IONS AND DECREASING AMPLITUDE OF TRAP RF TO DECREASE Q-VALUES OF IONS.
33 SCHEMATIC VIEW OF TRAPPED IONS BEING EJECTED SEQUENTIALLY FROM HIGH MASS SIDE BY THE RESONANCE EFFECT OF SUPPLEMENTAL AC
34 SCHEMATIC VIEW OF TRAPPED TARGET PRECURSOR ION REMAINING
35 TITLE OF SELECTION FOR ISOLATION METHOD
36 NORMAL MODE
37 ISOLATION-POWER-ORIENTED MODE
38 SOFT-ION MODE
39 OK-BUTTON
40 INTENSITY PEAK OF SUBSTANCE P AFTER ISOLATION
41 INTENSITY PEAK OF SUBSTANCE P BEFORE ISOLATION
42 PEAK OF ANOTHER ION DISTINGUISHED FROM SUBSTANCE P
43 AMPLITUDE OF TRAP RF REALIZED BY ANALOG CIRCUIT
44 AMPLITUDE OF TRAP RF REALIZED BY DIGITAL CIRCUIT

1. An ion isolation method, comprising:
an introduction step for introducing a plurality of ions into an ion trap having a plurality of electrodes;
a trapping step for applying an RF voltage to at least one of the plurality of electrodes at a first potential to trap the plurality of ions within the ion trap;
a first isolation step for applying a supplemental RF voltage to the electrode to which the RF voltage is applied, increasing the RF voltage above the first potential, and continuing the application of the RF voltage at the increased potential for a first time period such that ion isolation is performed;
a second isolation step for, with the supplemental RF voltage applied to the electrode to which the RF voltage is applied, reducing the RF voltage below the first potential, and continuing the application of the RF voltage at the reduced potential for a second time period shorter than the first time period such that ion isolation is performed; and
an ejection step for ejecting the ions remaining in the ion trap.

2. The ion isolation method according to claim 1, characterized in that the plurality of ions includes a peptide or a post-translationally modified peptide.

3. The ion isolation method according to claim 1, characterized in that the second time period divided by the first time period is equal to 1.2 or more.

4. The ion isolation method according to claim 3, characterized in that the second time period divided by the first time period is equal to 1.4 or more.

5. The ion isolation method according to claim 4, characterized in that the second time period divided by the first time period is equal to two or more, and the plurality of ions include reserpine.

6. The ion isolation method according to claim 2, characterized in that the second time period divided by the first time period is 1.2 to 1.4, and the plurality of ions include Substance P.

7. The ion isolation method according to claim 1, characterized in that in either the first isolation step or the second isolation step, or in both thereof, the RF voltage has an extreme value with respect to time.

8. The ion isolation method according to claim 7, characterized in that in either the first isolation step or the second isolation step, or in both thereof, the RF voltage is varied linearly with respect to time.

9. The ion isolation method according to claim 7, characterized in that in either the first isolation step or the second isolation step, or in both thereof, the RF voltage is varied nonlinearly with respect to time.

10. The ion isolation method according to claim 7, characterized in that in either the first isolation step or the second isolation step, or in both thereof, the RF voltage has a plurality of different gradients between the first potential and the extreme value, and a gradient from among the plurality of different gradients close to the extreme value is lower in magnitude than a gradient from among the plurality of the different gradients away from the extreme value.

11. The ion isolation method according to claim 8, characterized in that in either the first isolation step or the second isolation step, or in both thereof, a gradient of the RF voltage with respect to time differs in magnitude when compared before and after the extreme value.

12. The ion isolation method according to claim 9, characterized in that in either the first isolation step or the second isolation step, or in both thereof, a rate of change of the RF voltage with respect to time increases in magnitude as the RF voltage approaches the extreme value.

13. The ion isolation method according to claim 9, characterized in that in either the first isolation step or the second isolation step, or in both thereof, a rate of change of the RF voltage with respect to time decreases in magnitude as the RF voltage approaches the extreme value.

14. The ion isolation method according to claim 1, characterized in that in either the first isolation step or the second isolation step, or in both thereof, the RF voltage is represented by an arbitrary piecewise continuous function with respect to time.

15. The ion isolation method according to claim 14, characterized in that
in the first isolation step, the RF voltage has a maximum value, a differential coefficient of a curve followed by the RF voltage with respect to time is always positive or zero before the RF voltage reaches the maximum value except for a breakpoint, and the differential coefficient of the curve followed by the RF voltage with respect to time is always negative or zero after the RF voltage reaches the maximum value except for a breakpoint, and
in the second isolation step, the RF voltage has a minimum value, a differential coefficient of a curve followed by the RF voltage with respect to time is always negative or zero before the RF voltage reaches the minimum value except for a breakpoint, and the differential coefficient of the curve followed by the RF voltage with respect to time is always positive or zero after the RF voltage reaches the minimum value except for a breakpoint.

16. The ion isolation method according to claim 14, characterized in that
in the first isolation step, the RF voltage has a maximum value and varies in a straight line with respect to time before and after the RF voltage reaches the maximum value, and
in the second isolation step, the RF voltage has a minimum value and varies in a straight line with respect to time before and after the RF voltage reaches the minimum value.

17. The ion isolation method according to claim 16, characterized in that
in the first isolation step, the RF voltage varies in a straight line with respect to time before and after the RF voltage reaches the maximum value, a starting point of the straight line before the maximum value is a first breakpoint and is at a potential higher than the first potential, the RF voltage is at the first potential before the first breakpoint, and an ending point of the straight line after the maximum value is a second breakpoint and is at a potential higher than the first potential, and
in the second isolation step, the RF voltage varies in a straight line with respect to time before and after the RF voltage reaches the minimum value, a starting point of the straight line before the minimum value is a third breakpoint and is at a potential lower than the first potential, an ending point of the straight line after the minimum value is a fourth breakpoint and is at a potential lower than the first potential, and the RF voltage is at the first potential after the fourth breakpoint.

18. The ion isolation method according to claim 1, characterized by further comprising, before the introduction step, a step for selecting one of a plurality of modes having predetermined distinct sets of first and second time periods.

19. A mass spectrometer, comprising:
an ion source unit for generating a plurality of ions by ionizing a sample;
an ion trap unit including an ion trap having a plurality of electrodes, an AC power supply for applying an AC electric field to the plurality of electrodes, and a controller for controlling the AC power supply; and
a detector unit for detecting the plurality of ions depending on their mass-to-charge ratios, characterized in that
the controller controls the AC power supply to perform ion isolation by applying the RF voltage to at least one of the plurality of electrodes at a first potential to trap the plurality of ions, applying the supplemental RF voltage to the electrode to which the RF voltage is applied, increasing the RF voltage above the first potential, continuing the application of the RF voltage at the increased potential for a first time period, reducing the RF voltage below the first potential, and continuing the application of the RF voltage at the reduced potential for a second time period that is shorter than the first time period.

20. The mass spectrometer according to claim 19, characterized by further comprising a user interface unit connected with the controller, the user interface unit displaying a plurality of modes having predetermined sets of first and second time periods.
